(19) United States
(12) Patent Application Publication
(10) Pub. No.: US 2026/0318774 A1
(43) Pub. Date: Oct. 15, 2026

(54) DUPLICATE OPTICAL FIBER TEST IDENTIFICATION

(71) Applicant: EXFO Inc., Quebec (CA)

(72) Inventors: Justin M. Whatley, Wolfville (CA); Jonathan Plante, Montreal (CA); Renaud Lesperance, Montreal (CA)

(21) Appl. No.: 19/629,599

(22) Filed: Mar. 26, 2026

Related U.S. Application Data
(60) Provisional application No. 63/786,536, filed on Apr. 10, 2025.
(60) Provisional application No. 63/850,019, filed on Jul. 24, 2025.

(51) Int. Cl. G01M 11/00; G06T 7/00; G06T 7/11

(52) U.S. Cl. CPC G01M 11/3109; G01M 11/33; G06T 7/0002; G06T 7/11; G06T 2207/20081; G06T 2207/20084

(57) ABSTRACT

Example embodiments relate to duplicate optical fiber test identification. One example embodiment includes a method. The method includes receiving, by a computing device, first fiber characterization data having first associated metadata and second fiber characterization data having second associated metadata. The first fiber characterization data is generated based on a first optical fiber test and the second fiber characterization data is generated based on a second optical fiber test. The method also includes determining, by the computing device using a machine-learned model, a first embedding vector and a second embedding vector. Further, the method includes comparing, by the computing device, the associated metadata to one another. In addition, the method includes determining, by the computing device, a similarity score based on the embedding vectors. Still further, the method includes determining, by the computing device, that the first optical fiber test and the second optical fiber test represent duplicate tests.

### CROSS-REFERENCE TO RELATED APPLICATIONS

The present application claims the benefit of U.S. Provisional Patent Application No. 63/786,536, filed Apr. 10, 2025, and U.S. Provisional Patent Application No. 63/850,019, filed Jul. 24, 2025. The contents of U.S. Provisional Patent Application No. 63/786,536, filed Apr. 10, 2025, and U.S. Provisional Patent Application No. 63/850,019, filed Jul. 24, 2025, are hereby incorporated by reference in their entireties.

### BACKGROUND

Optical fibers are optical components that transmit light from one end to another using total internal reflection. They can be made of glass or plastic and are widely used in telecommunications, lasers, and sensors.

Operating a communication network may require the installation, repair, and/or testing of optical fibers within the communication network. These tasks may be performed by technicians (e.g., test engineers trained to test optical fibers). In some cases, technicians may perform a test job that includes characterizing many optical fibers and optical fiber connectors (e.g., hundreds of optical fibers and optical fiber connectors). For example, test jobs may include endface inspection of optical-fiber connectors using an optical-fiber connector endface inspection probe and/or optical time-domain reflectometry (OTDR) measurements of each individual fiber. Further, performing a test job may include preparing a test report (e.g., for submission to a network operator). In the context of installation or repair, a satisfactory test report may be required prior to commissioning a respective optical fiber (or collection of optical fibers) for subsequent communication.

### SUMMARY

The specification and drawings disclose embodiments that relate to duplicate optical fiber test identification.

In a first aspect, the disclosure describes a method. The method includes receiving, by a computing device, first fiber characterization data having first associated metadata and second fiber characterization data having second associated metadata. The first fiber characterization data is generated based on a first optical fiber test and the second fiber characterization data is generated based on a second optical fiber test. The method also includes determining, by the computing device using a machine-learned model, a first embedding vector for the first fiber characterization data. Additionally, the method includes determining, by the computing device using the machine-learned model, a second embedding vector for the second fiber characterization data. Further, the method includes comparing, by the computing device, the first associated metadata to the second associated metadata to determine a testing condition score. In addition, the method includes determining, by the computing device, a similarity score. Determining the similarity score includes comparing the first embedding vector to the second embedding vector. Still further, the method includes determining, by the computing device based on the testing condition score and the similarity score, that the first optical fiber test and the second optical fiber test represent duplicate tests.

In a second aspect, the disclosure describes a non-transitory, computer-readable medium having instructions stored therein. The instructions, when executed by a processor, perform a method. The method includes receiving first fiber characterization data having first associated metadata and second fiber characterization data having second associated metadata. The first fiber characterization data is generated based on a first optical fiber test and the second fiber characterization data is generated based on a second optical fiber test. The method also includes determining, using a machine-learned model, a first embedding vector for the first fiber characterization data. Additionally, the method includes determining, using the machine-learned model, a second embedding vector for the second fiber characterization data. Further, the method includes comparing the first associated metadata to the second associated metadata to determine a testing condition score. In addition, the method includes determining a similarity score. Determining the similarity score includes comparing the first embedding vector to the second embedding vector. Still further, the method includes determining, based on the testing condition score and the similarity score, that the first optical fiber test and the second optical fiber test represent duplicate tests.

In a third aspect, the disclosure describes a system. The system includes a fiber characterization device. The fiber characterization device includes an OTDR device or a fiber inspection probe configured to acquire a plurality of fiber inspection images. The OTDR device includes a laser configured to emit a series of light pulses into an optical fiber. The OTDR device also includes a light detector configured to acquire a plurality of OTDR traces. The OTDR traces represent backscatter from respective light pulses of the series of emitted light pulses propagated through the optical fiber. The system also includes a computing device communicatively coupled with the fiber characterization device. The computing device is configured to receive, from the fiber characterization device, first fiber characterization data having first associated metadata and second fiber characterization data having second associated metadata. The first fiber characterization data is generated based on a first optical fiber test and the second fiber characterization data is generated based on a second optical fiber test. The computing device is also configured to determine, using a machine-learned model, a first embedding vector for the first fiber characterization data. Additionally, the computing device is configured to determine, using the machine-learned model, a second embedding vector for the second fiber characterization data. Further, the computing device is configured to compare the first associated metadata to the second associated metadata to determine a testing condition score. In addition, the computing device is configured to determine a similarity score. Determining the similarity score includes comparing the first embedding vector to the second embedding vector. Still further, the computing device is configured to determine, based on the testing condition score and the similarity score, that the first optical fiber test and the second optical fiber test represent duplicate tests.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 is a block diagram illustration of a computing device, according to example embodiments.

FIG. 2 is a block diagram illustration of a cloud-based server cluster, according to example embodiments.

FIG. 3A is a diagram illustrating a system, according to example embodiments.

FIG. 3B is a block diagram illustrating a device, according to example embodiments.

FIG. 3C is a block diagram illustrating an OTDR acquisition device of the device of FIG. 3B, according to example embodiments.

FIG. 4A is an illustration of a method for training a machine-learned model, according to example embodiments.

FIG. 4B is an illustration of a method for making a prediction using a machine-learned model, according to example embodiments.

FIG. 5A is a plot illustrating an OTDR trace, according to example embodiments.

FIG. 5B is an illustration of a fiber inspection image, according to example embodiments.

FIG. 6 is timing diagram illustrating multiple optical fiber tests, according to example embodiments.

FIG. 7A is a plot illustrating embedding vectors and a similarity score, according to example embodiments.

FIG. 7B is a plot illustrating an embedding vector and a threshold distance, according to example embodiments.

FIG. 7C is a plot illustrating embedding vectors and clusters, according to example embodiments.

FIG. 8A is a block diagram of a technique for identifying duplicate optical fiber tests, according to example embodiments.

FIG. 8B is a block diagram of a technique for training a machine-learned model used to determine embedding vectors of fiber characterization data, according to example embodiments.

FIG. 9 is a flowchart diagram illustrating a method, according to example embodiments.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. In addition, some of the illustrated elements may be combined or omitted. Similarly, an example embodiment may include elements that are not illustrated in the figures.

As used herein, the terms “duplicate test,” “duplicate optical fiber test,” “duplicated test,” and “duplicated optical fiber test” may each represent a repeated testing of the same optical fiber. This may include successive, repeated tests of a single optical fiber without substantially changing the testing conditions (e.g., without changing testing location and/or type of optical fiber test). Duplicate tests may be performed by test engineers in nonconformance with testing standards (e.g., to spoof the testing of different optical fibers in order to enhance the rate at which required testing is completed and/or to falsely indicate a nonconforming optical fiber conforms with required standards).

### 1. Overview

As described above, test jobs may be performed in order to characterize optical fibers within a communication network prior to deploying the optical fibers and/or when repairing the optical fibers. However, testing many fibers can be a time-consuming, arduous process (e.g., connecting a testing device to connectors of each of a large number of optical fibers may require manipulation, including cleaning). Further, measurement results that indicate noncompliance with one or more criteria (e.g., network operator acceptance criteria, such as PASS/FAIL thresholds) may involve additional manipulation (e.g., to clean or repair a noncompliant connector prior to retesting). Thus, in order to save time, there exists an incentive for technicians to fake test jobs or portions of test jobs by repeating an optical-fiber connector endface inspection or an OTDR measurement on the same optical fiber (e.g., repeating a measurement on a conforming optical fiber) while claiming that the subsequent test was performed on different optical fibers.

For example, a technician may identify a compliant optical fiber or connector (e.g., an optical fiber that satisfies one or more criteria) and then, rather than moving on to subsequent optical fibers or connectors for testing, retest the compliant optical fiber (e.g., while claiming to connect to the subsequent optical fiber before launching the subsequent test). As a result of retesting compliant optical fibers and/or connectors, deficient optical fibers and/or connectors (i.e., optical fibers and/or connectors that would have failed to satisfy the one or more criteria) go undetected.

As a result of the above, it can be desirable to identify (and, ideally, eradicate) duplicated tests. One technique of doing so involves detecting duplicated test data files by auditing the test report. However, such an audit will not detect repeated interrogations of the same optical fiber and/or connector when those interrogations are saved in different data files. In other techniques, subsequent fiber inspection images may be compared to one another or subsequent OTDR measurements may be compared to one another, in order to attempt to detect duplicates. However, when these techniques are used to review test results of clean and/or high-quality optical fibers and optical-fiber connectors or to review OTDR measurements, such techniques may result in a high number false-positives (i.e., purportedly duplicated tests that, in reality, are tests of different, high-quality optical fibers), especially when the optical fibers or optical-fiber connectors are precisely manufactured to be of the same length and cross-sectional size as one another. Further, by incorrectly identifying duplicated tests, this may result in unnecessary further additional tests (e.g., tests to confirm that separate fibers were, in fact, tested) and/or consumption of additional computing resources (e.g., communication bandwidth between a central testing server and a testing device, memory and/or processing resources on-board a testing device to process optical fiber tests, memory and/or processing resources on-board a central testing server attempting to identify inappropriately repeated tests, etc.). Thus, a reliable way for identifying duplicated optical fiber testing would reduce the number of false positives and, as a result, provide improved use of computational resources (e.g., reduced memory and/or processing power required to identify duplicated tests).

Example embodiments provided herein provide reliable techniques for identifying duplicated optical fiber tests that reduce the number of false positives (and, as a result, provide improved use of computational resources). In particular, the techniques described herein may be used to compare two (or more) sets of fiber characterization data (e.g., with associated metadata) in order to determine whether those sets of characterization data resulted from a repeated testing of the same optical fiber and/or the same optical-fiber connector. Fiber characterization data may include, for example, OTDR traces, fiber inspection images (e.g., optical-fiber connector endface inspection images), optical loss test set (OLTS) measurements from multiple optical fibers connected to a multi-fiber push on (MPO) connector, power measurements for various channels of a dense wavelength division multiplexing (DWDM) channel checker, spectral profiles based on different testing wavelengths from an optical spectrum analyzer, data from a dispersion analyzer (e.g., chromatic dispersion measurements or polarization mode dispersion measurements), or radio-frequency (RF) spectrum data from a spectrum analyzer. In various embodiments, fiber characterization data may be one-dimensional, two-dimensional, three-dimensional, or n-dimensional. For instance, fiber characterization data may include a one-dimensional signal result or a two-dimensional image. Comparing two (or more) optical fiber tests may be performed on an optical fiber testing device (e.g., a handheld OTDR acquisition device or a handheld fiber inspection device), on a mobile computing device (e.g., a technician's smartphone that is communicatively coupled to an optical fiber testing device), and/or on a server computing device (e.g., a cloud computing service provided by a supplier of optical fiber test devices that is communicatively coupled with one or more supplied optical fiber test devices).

According to example embodiments, the techniques described herein may include determining a multi-dimensional embedding vector (e.g., using a previously trained machine-learned model) for each of the sets of fiber characterization data corresponding to respective optical fiber tests. Thereafter, techniques described herein may include determining a similarity score by comparing the embedding vectors. For example, a Euclidean distance may be calculated between the embedding vectors (e.g., and normalized) in order to determine the similarity score.

Further, techniques described herein may include determining testing condition scores by comparing metadata associated with each of the optical fiber tests to one another (e.g., based on metadata associated with the sets of fiber characterization data). For example, a technician performing non-duplicated optical fiber tests may test a patch-panel, one fiber at a time, until there is a brief pause. Then, the technician may start a new series of a tests until the technician stops and move to a different geographic area. Thus, the temporal and/or spatial aspects of the optical fiber tests may be used to assist in the identification of duplicated optical fiber tests. As such, the testing condition score may be determined to quantify various temporal or spatial aspects of the various optical fiber tests. For example, the testing condition score may be based on the separation in time between the optical fiber tests (e.g., between the conclusion of one optical fiber test and the initiation of a subsequent optical fiber test), the rate at which optical fiber tests are being performed, the time required to setup testing conditions for a second of two optical fiber tests, the specific ordering of various optical fiber tests (e.g., if tests of the same type are performed successively, such as an optical fiber test followed by an optical fiber test versus an optical fiber test followed by an optical-fiber connector test), the separation between physical locations (e.g., global position system (GPS) location) where the respective optical fiber tests were performed, etc.

Then, based on the testing condition score and the similarity score, duplicated (e.g., inappropriately repeated) optical fiber tests may be identified. For example, a formula that includes a weighting for the testing condition score and a weighting for the similarity score may be used. Upon evaluating the formula, the resulting combination of the weighted testing condition score and the weighted similarity score may be compared to a threshold used to identify duplicated tests. Alternatively, one of the scores (e.g., the testing condition score) may be used to identify potentially duplicated optical fiber tests and the other score (e.g., the similarity score) may be used to confirm which of the potentially duplicated optical fiber tests are, in fact, duplicated optical fiber tests. For example, the testing condition score may indicate (e.g., by comparing to a threshold) which optical fiber tests are sufficiently close to one another in time and/or in location so as to represent potentially duplicated optical fiber tests. Thereafter, the similarity score may be used to determine (e.g., by comparing to a threshold) which of those potentially duplicated optical fiber tests produced results that are similar enough so as to constitute actually duplicated optical fiber tests.

Each threshold used herein (e.g., the thresholds for testing condition score, similarity score, and/or a weighted combination of testing condition score and similarity score) may be determined in a variety of ways. For example, one or more thresholds may be established by comparing results from known duplicated tests and known non-duplicated optical fiber tests. For instance, a series of similarity scores may be determined between embedding vectors generated based on synthetic data (e.g., synthetic fiber characterization images and associated metadata) that was generated to simulate duplicated optical fiber tests (e.g., multiple optical fiber tests that provide identical or very similar fiber characterization images). Similarly, a series of similarity scores may be determined between embedding vectors generated based on synthetic data that was generated to simulate non-duplicated optical fiber tests (e.g., multiple optical fiber tests that provide different fiber characterization images).

In some embodiments, determining similarity scores between the embedding vectors of various optical fiber tests may include performing one or more clustering techniques (e.g., a graph-based clustering technique, a density-based spatial clustering of applications with noise (DBSCAN) technique to find clusters of similar test results, or a k-means clustering technique with k=2 to find candidate pairs) to identify those embedding vectors that are sufficiently close to one another (e.g., so as to potentially form a group of related optical fiber test results).

### II. Example Systems

The following description and accompanying drawings will elucidate features of various example embodiments. The embodiments provided are by way of example, and are not intended to be limiting. As such, the dimensions of the drawings are not necessarily to scale.

The manufacturing processes used for optical fibers can produce small fluctuations in the optical fiber structure along one or more segments of the optical fiber. Variations along the optical fiber may also be the result of environmental factors (e.g., dust, moisture, or abrasion) introduced during installation and/or maintenance. Fiber inspection images may be captured of the optical fiber and/or associated optical-fiber connectors and reviewed in order to identify any defects along the optical fiber and/or associated optical-fiber connectors. For example, images of optical fibers or associated optical-fiber connector(s) may be captured using an optical-fiber connector endface inspection probe. These images may be compared to one another across a plurality of optical fibers (e.g., in order to compare the optical fibers to one another). In some embodiments, fiber inspection images may include a core of the optical fiber under test, one or more claddings of the optical fiber under test, one or more coatings of the optical fiber, one or more jackets of the optical fiber, and/or portions of an optical-fiber connector. Even further, in some embodiments, fiber inspection images may include portions of the environment surrounding the respective optical fiber (e.g., exterior to the jacket(s) of the respective optical fiber).

In addition to or instead of using fiber inspection images to inspect an optical fiber, OTDR may be used to characterize optical fibers. OTDR may include a diagnostic technique in which light pulses are launched into an optical fiber and the returning light (e.g., arising from backscattering and reflections along the optical fiber) is acquired and analyzed (e.g., by an OTDR acquisition device). Various “events” along the optical fiber may be detected and characterized through an analysis of the returning light in the time domain. As a result, the insertion loss of the optical fiber under test, as well as each component along the optical fiber, may be characterized and/or localized using OTDR.

The acquired power level of the return signal as a function of time may be referred to as the “OTDR trace” (i.e., the “reflectometric trace”). Further, the point in time along the OTDR trace may be representative of the distance between the OTDR acquisition device and a point along the optical fiber. In the following description, general OTDR measurement techniques and OTDR trace processing techniques will not be explained in detail herein. For example, traditional signal processing methods for identifying and characterizing events from an OTDR trace will not be described in detail. Similarly, optical hardware and electronics present in an OTDR acquisition device for performing OTDR acquisitions on an optical fiber will not be described in an overly detailed fashion.

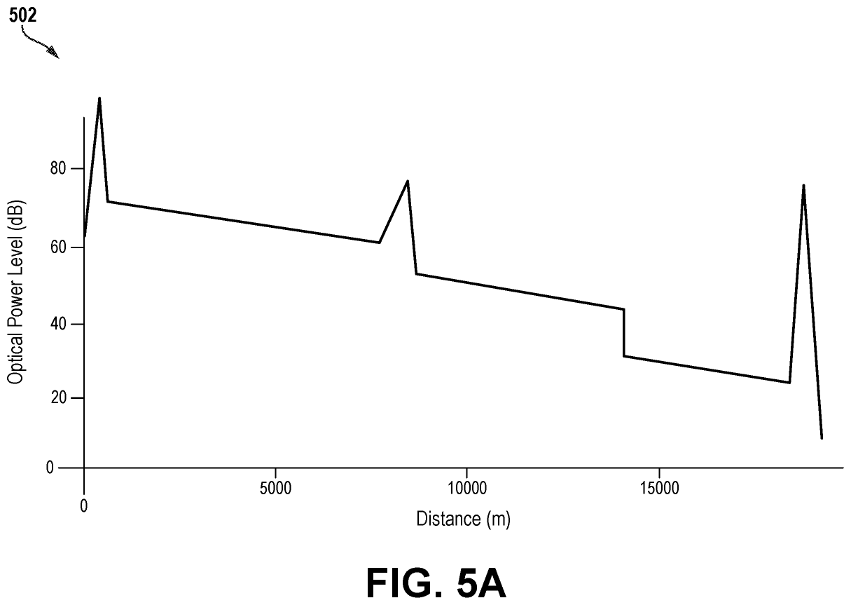

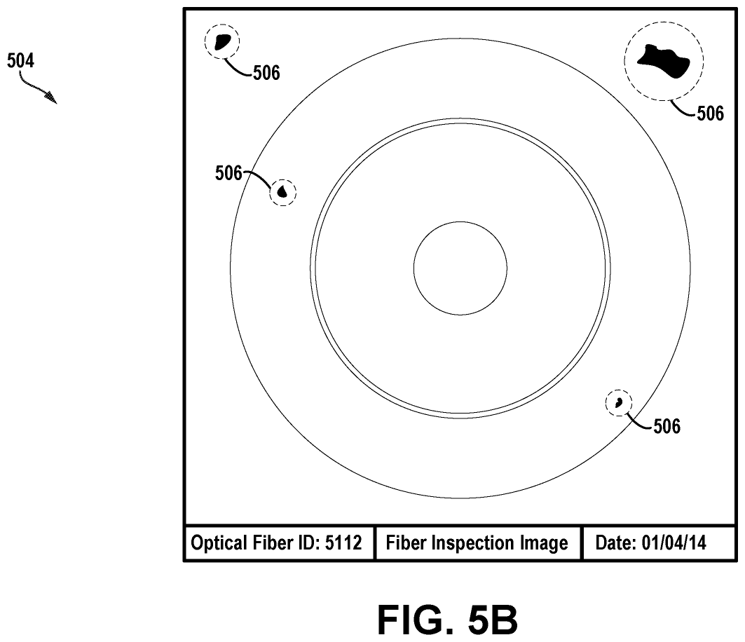

In the context of OTDR techniques, each light acquisition may involve propagating a large number of substantially identical light pulses in an optical fiber and combining the results. Each “OTDR acquisition” is understood to refer to the actions of propagating a test signal that includes one or more test light pulses having the same pulse width in the optical fiber and detecting corresponding return light signal from the optical fiber as a function of time. A test light-pulse signal travelling along the optical fiber will return towards its point of origin either through (distributed) backscattering or (localized) reflections. Multiple return light pulses representative of the acquired power level of backscatter and reflections of test light pulses may be averaged over time. Such an averaged set of return light pulses represent an OTDR trace. In an OTDR trace, the return time may be representative of the distance between the OTDR acquisition device and a point along the optical fiber. Light acquisitions may be repeated with varied acquisition parameters to produce a separate OTDR trace for each set of acquisition parameters (e.g., pulse widths, sampling rates, gain values, bandwidths, wavelengths, etc.). An example OTDR trace is shown and described with reference to FIG. 5A.

As used herein, “backscattering” refers to Rayleigh scattering occurring from the interaction of the travelling light with the optical fiber media all along the optical fiber, resulting in a generally sloped reflected signal (e.g., measured in logarithmic units such as dB) for the OTDR trace. “Events” along the optical fiber may result in a localized drop of the backscattered light on the OTDR trace (e.g., which is attributable to a localized loss) and/or in a localized reflection peak on the OTDR trace.

An “event” characterized by the OTDR techniques described herein may be generated by any perturbation along the optical fiber that affects the returning light. For example, an event may be generated by an optical fiber splice along the optical fiber, which may be characterized by a localized loss with little or no reflection. Additionally or alternatively, mating connectors may generate events that typically cause enhanced reflections (although such connectors may be difficult to detect in some instances). OTDR techniques may also be used to identify events such as an optical fiber breakage (e.g., characterized by substantial localized loss and, frequently, a concomitant reflection peak) and/or a bend in the optical fiber (e.g., characterized by a wavelength-dependent loss). Still further, any other component along the optical fiber may also give rise to an “event” that generates localized loss.

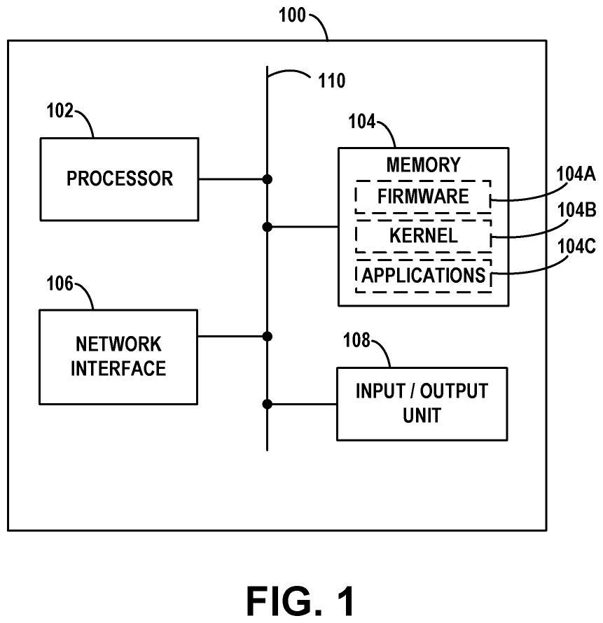

FIG. 1 is a block diagram of a computing device 100, according to example embodiments. FIG. 1 illustrates some of the components that may be included in a computing device arranged to operate in accordance with the embodiments herein. For example, the computing device 100 may represent portions of an optical fiber characterization device (e.g., including a fiber inspection probe, an OTDR acquisition device, an OLTS device, a DWDM channel checker, an optical spectrum analyzer, a dispersion analyzer, etc.), such as a handheld optical fiber characterization device. Computing device 100 may be a client device (e.g., a device actively operated by a user, such as a mobile device), a server device (e.g., a device that provides computational services to client devices), or some other type of computational platform. For example, computing device 100 may be a server device used to identify duplicated optical fiber tests, as described herein. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a CPU, a co-processor (e.g., a mathematics, graphics, or encryption co-processor, a neural processing unit (NPU), or a tensor processing unit (TPU)), a digital signal processor (DSP), a graphics processing unit (GPU), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. In some embodiments, for example, firmware 104A may include a basic input/output system (BIOS). Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs (e.g., mobile applications), such as web browsers, games, or email clients, as well as any software libraries used by these programs. For example, in some embodiments, applications 104C may include one or more machine-learned models used to carry out the duplicate optical fiber testing analyses described herein (e.g., to generate embedding vectors for fiber characterization data, as described herein). Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (WIFI), BLUETOOTH, global positioning system (GPS), third-generation (3G), fourth-generation (4G), long-term evolution (LTE), fifth-generation (5G), or a wide-area wireless interface. However, other forms of physical layer interfaces and other types of standard or proprietary communication protocols may be used over network interface 106. Furthermore, network interface 106 may include multiple physical interfaces. For instance, some embodiments of computing device 100 may include Ethernet, BLUETOOTH, and WIFI interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support the embodiments herein. The exact physical location, connectivity, and configuration of these computing devices may be unknown and/or unimportant to client devices. Accordingly, the computing devices may be referred to as “cloud-based” devices that may be housed at various remote data center locations.

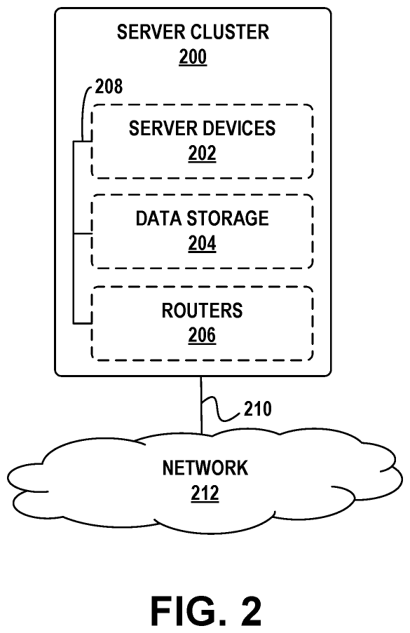

FIG. 2 depicts a server cluster 200 (e.g., a cloud-based server cluster) in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature is understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Routers 206 may include networking equipment configured to provide internal and external communications for server cluster 200. For example, routers 206 may include one or more packet-switching and/or routing devices (including switches and/or gateways) configured to provide: (i) network communications between server devices 202 and data storage 204 via local cluster network 208 and/or (ii) network communications between server cluster 200 and other devices via communication link 210 to network 212.

Additionally, the configuration of routers 206 can be based at least in part on the data communication requirements of server devices 202 and data storage 204; the latency and throughput of the local cluster network 208; the latency, throughput, and cost of communication link 210; and/or other factors that may contribute to the cost, speed, fault-tolerance, resiliency, efficiency, and/or other design goals of the system architecture.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations (e.g., accessible via a web browser). Such a representation may take the form of a markup language, such as HyperText Markup Language (HTML), eXtensible Markup Language (XML), or some other standardized or proprietary format. Moreover, server devices 202 may have the capability of executing various types of computerized scripting languages, such as, but not limited to, Perl, Python, PHP Hypertext Preprocessor (PHP), Active Server Pages (ASP), JAVASCRIPT, and so on. Computer program code written in these languages may facilitate the providing of web pages to client devices, as well as client device interaction with the web pages. Alternatively or additionally, JAVA may be used to facilitate generation of web pages and/or to provide web application functionality.

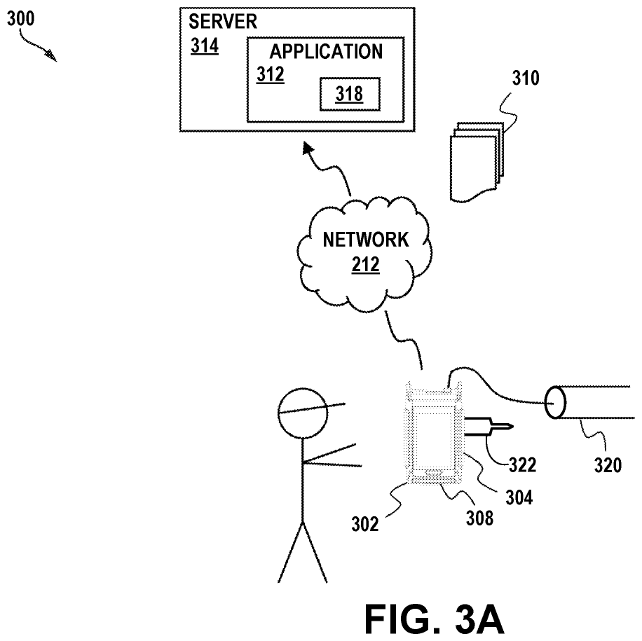

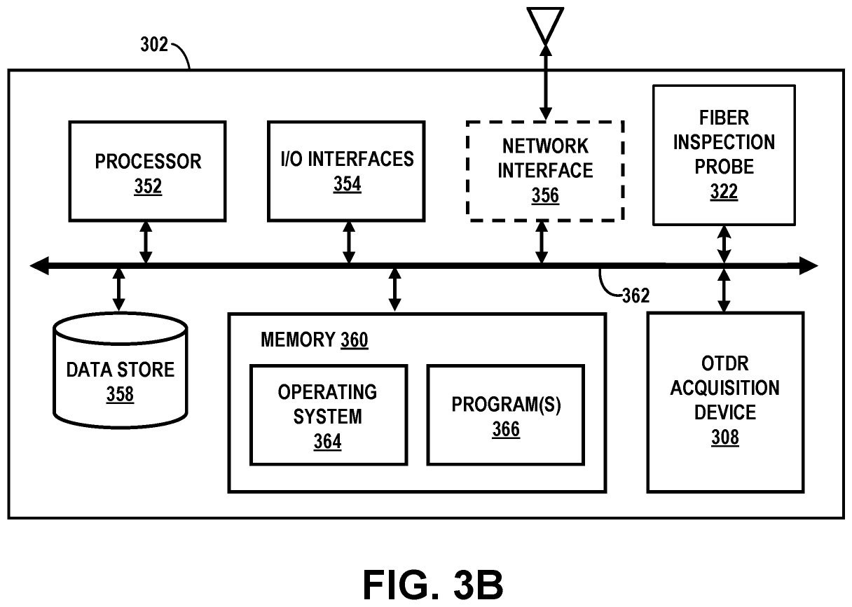

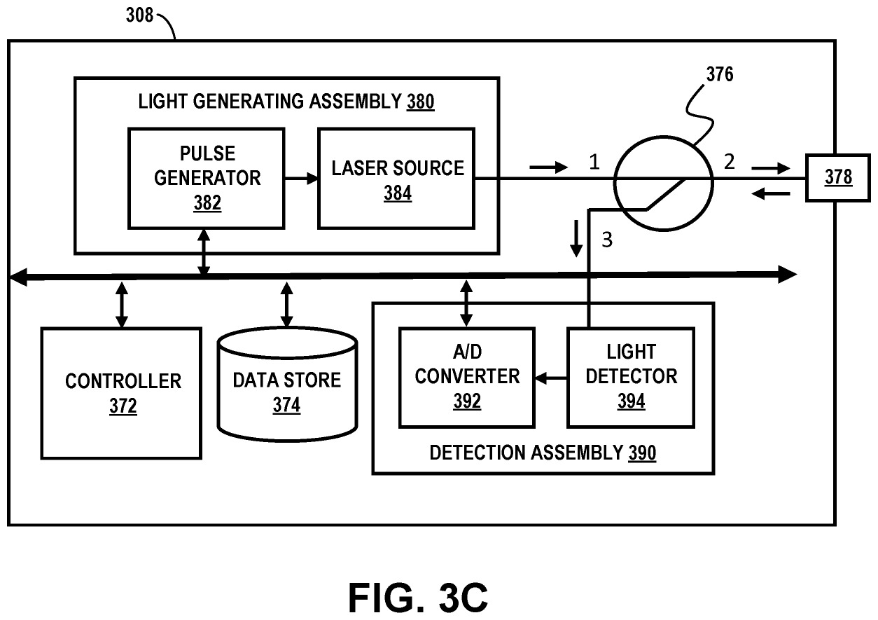

FIG. 3A illustrates a system 300 configured to generate, communicate, and store measurement results (e.g., initiated by a network operator or technician). Such measurement results may include OTDR traces and/or fiber inspection images (e.g., from a fiber inspection probe).

The system 300 may include a device 302 that includes an OTDR acquisition device 308 configured to perform OTDR measurements on an optical fiber 320 (e.g., an optical fiber that is at least 1 km, at least 5 km, at least 10 km, at least 15 km, at least 20 km, at least 25 km, at least 50 km, or at least 100 km in length) and/or a fiber inspection probe 322. When testing the optical fiber 320, the OTDR acquisition device 308 and/or the fiber inspection probe 322 may generate one or more measurement data files 310 for the optical fiber test (e.g., each of which may include one or more sets of fiber characterization data, such as OTDR traces and/or fiber inspection images that were acquired to characterize the optical fiber 320 and as shown and described in further detail with reference to FIGS. 5A and 5B). In some embodiments, the measurement data files 310 may also include metadata related to the fiber characterization data for the optical fiber test (e.g., the geographic location of the optical fiber test, the time at which the optical fiber test began, the time at which the optical fiber test ended, the duration of the optical fiber test, an identification number of the interrogated optical fiber recorded by a technician for the optical fiber tested during the optical fiber test, a name of the optical fiber test assigned by a technician, etc.). Additionally or alternatively, the measurement data files 310 may include parameters of the optical fiber 320 (e.g., as determined by the device 302 based on the acquired OTDR trace(s) or based on the fiber inspection image(s)).

The measurement data files 310 may be transferred to a server-based test application 312 that receives the measurement data files 310 and may optionally track the progress and completion of the optical fiber test and/or accept and/or verify measurement data files 310. The test application 312 may be located in a server 314 (e.g., similar to the server devices 202 in the server cluster 200 shown and described with reference to FIG. 2). The server 314 and the device 302 may communicate over a network (e.g., such as the network 212 shown and described with reference to FIG. 2). In some embodiments, a test report may be prepared by the technician (e.g., using the device 302) and transferred to the test application 312 (e.g., via the network 212) in addition to or instead of the measurement data files 310 (e.g., including the fiber characterization data). In some embodiments, a test report may be prepared by the test application 312.

The fiber inspection probe 322 may be a device used to capture images (e.g., fiber inspection images) of the optical fiber 320 and/or connectors associated with the optical fiber 320. For example, the fiber inspection probe 322 may be an optical-fiber connector endface inspection probe. It is understood that, as used herein, a “fiber inspection probe” may be interchangeably referred to as a fiber inspection scope, a fiber inspection microscope, or a fiber inspection camera. In some embodiments, the fiber inspection probe 322 may include multiple interchangeable adapters (e.g., female and male adapters or tips) used to interface the fiber inspection probe 322 with multiple types of optical fibers under test and/or multiple types of connectors under test. While the fiber inspection probe 322 is illustrated in FIG. 3A as being physically attached to the device 302, it is understood that this is only provided as an example and other configurations are also possible. For example, the fiber inspection probe 322 may be a wireless device configured to communicate captured fiber inspection images back to the device 302 and/or to the server 314 (e.g., via WIFI or BLUETOOTH communication). In some embodiments, in addition to or instead of the OTDR acquisition device 308 and/or the fiber inspection probe 322, the device 302 may include a measurement system configured to connect multiple optical fibers to a MPO connector of the device 302, a DWDM channel checker, an optical spectrum analyzer, a dispersion analyzer, and/or a spectrum analyzer. For example, in some embodiments, the device 302 may include a MPO connector configured to connect to twelve or more optical fibers simultaneously and used measure OLTS results from the respective fibers. The OLTS results (e.g., as a first set of fiber characterization data) may thereafter be compared to OLTS results (e.g., as a second set of fiber characterization data) from the MPO connector being connected to a different set of twelve or more optical fibers.

In the system 300 illustrated in FIG. 3A, the test application 312 and/or the device 302 may include a duplicate test identification module 318. The duplicate test identification module 318 may be configured to accept the measurement data files 310 and, based on the data files, identify duplicated optical fiber tests. Additionally or alternatively, the device may include a module configured to determine various characteristics about the optical fiber 320 based on one or more measurement data files 310.

FIG. 3B is a block diagram of a device (e.g., the device 302 shown and described with reference to FIG. 3A). The device 302 may be a digital device that includes a processor 352 (e.g., similar to the processor 102 shown and described with reference to FIG. 1), input/output (I/O) interfaces 354 (e.g., similar to the input/output unit 108 shown and described with reference to FIG. 1), a network interface 356 (e.g., similar to the network interface 106 shown and described with reference to FIG. 1), a data store 358, a memory 360, an OTDR acquisition device (e.g., similar to the OTDR acquisition device 308 shown and described with reference to FIG. 3A), and a fiber inspection probe (e.g., similar to the fiber inspection probe 322 shown and described with reference to FIG. 3A). In other embodiments, additional and/or alternative components may be included in the device 302.

A local interface 362 may interconnect one or more of the components of FIG. 3B. The local interface 362 may include, for example, one or more buses or other wired or wireless connections. In some embodiments, the local interface 362 may include controllers, buffers (caches), drivers, repeaters, and/or receivers to enable communication between components. Further, the local interface 362 may include address, control, and/or data connections that enable appropriate data routing among the components of the device 302.

When the device 302 is in operation, the processor 352 may be configured to execute instructions stored within the memory 360, to communicate data to and from the memory 360 and/or to control operations of the device 302. In some embodiments, the processor 352 may include a mobile processor optimized for power consumption and/or mobile applications. The I/O interfaces 354 may be used to receive user input from and/or for providing system output. User input can be provided via, for example, a keypad, a mouse, a touch screen, a scroll ball, a scroll bar, buttons, a barcode scanner, etc. Further, outputs from the device 302 may be displayed on one or more display devices of the I/O interfaces 354 (e.g., a liquid crystal display (LCD), touch screen, etc.). The I/O interfaces 354 may include a graphical user interface (GUI) that enables a user to interact with the device 302.

The network interface 356 may enable wireless communication to an external access device or network. Any number of suitable wireless data communication protocols, techniques, or methodologies may be supported by the network interface 356.

The data store 358 may be used to store data, such as fiber characterization data (e.g., fiber inspection images and/or OTDR traces) and associated metadata (e.g., within a measurement file). In some embodiments, the data store 358 may include any of volatile memory elements (e.g., RAM), nonvolatile memory elements (e.g., ROM), and/or combinations thereof. Moreover, the data store 358 may incorporate electronic, magnetic, optical, and/or other types of storage media.

The memory 360 may include any of volatile memory elements (e.g., RAM), nonvolatile memory elements (e.g., ROM), and/or combinations thereof. Moreover, the memory 360 may incorporate electronic, magnetic, optical, and/or other types of storage media. In some embodiments, the memory 360 may have a distributed architecture, where various components are situated remotely from one another, but can be accessed by the processor 352. The computer-readable instructions stored within memory 360 can include one or more computer programs 366, each of which may include one or more ordered listings of executable instructions for implementing logical functions. As illustrated, memory 360 may include an operating system (O/S) 364 in addition to computer programs 366. The operating system 364 may control the execution of other computer programs 366 and/or provide scheduling, input-output control, file and data management, memory management, and communication control and related services. The programs 366 may include various applications, add-ons, etc. configured to provide end-user functionality with the device 302. For example, programs 366 may include a web browser to connect with a server for transferring measurement data files and/or a dedicated application configured to control OTDR acquisitions by the OTDR acquisition device 308 and/or fiber inspection image captures by the fiber inspection probe 322, analyze OTDR traces obtained by the OTDR acquisition device 308 and/or fiber inspection images captured by the fiber inspection probe 322, and display a GUI related to the device 302.

It is noted that, in some embodiments, the I/O interfaces 354 may be provided by a physically distinct mobile device (not illustrated), such as a handheld computer, a smartphone, a tablet computer, a laptop computer, a wearable computer etc. For example, a mobile device may be communicatively coupled to the device 302 via the network interface 356. In such cases, at least some of the programs 366 may be located in a memory of such a mobile device, for execution by a processor of the mobile device. Further, in some embodiments, the mobile device may also include a network interface used to transfer measurement data files 310 to a server 314.

The device 302 shown and described with reference to FIGS. 3A and 3B is provided solely as an example. Additional and alternative components for the device 302 are also possible.

FIG. 3C is a block diagram illustrating an OTDR acquisition device (e.g., the OTDR acquisition device 308 shown and described with reference to FIGS. 3A and 3B). As illustrated in FIG. 3A, the OTDR acquisition device 308 may be connectable to an optical fiber 320 in order to perform one or more OTDR measurements. For example, the OTDR acquisition device 308 may be connected via an output interface 378 to the optical fiber 320 in order to perform OTDR acquisitions. The OTDR acquisition device 308 may include optical hardware and electronics in order to perform OTDR measurements of the optical fiber 320. For example, the OTDR acquisition device 308 may include a light generating assembly 380, a detection assembly 390, a directional coupler 376, a controller 372, and a data store 374.

The light generating assembly 380 may include a laser source 384 that is driven by a pulse generator 382 to generate an OTDR test signal that includes test light pulses having one or more predefined characteristics. The light generating assembly 380 may be configured to generate test light pulses of varied pulse widths, repetition periods, and/or optical powers through control of the pattern produced by the pulse generator 382. In some cases, different OTDR measurements may be performed at different wavelengths. For this reason, in some embodiments, the light generating assembly 380 may be configured to generate test light pulses that have different wavelengths by including a tunable laser source 384. In some embodiments, the light generating assembly 380 may include both pulse width and wavelength control capabilities. In some embodiments, the light generating assembly 380 may include additional or alternative components, such as modulators, lenses, mirrors, optical filters, wavelength selectors, etc.

The light generating assembly 380 may be coupled to the output interface 378 of the OTDR acquisition device 308 through a directional coupler 376 (e.g., a circulator) that has three or more ports. The first port may be connected to the light generating assembly 380 to receive the test light pulses therefrom. The second port may be connected to the output interface 378. The third port may be connected to the detection assembly 390. The connections may be arranged such that test light pulses generated by the light generating assembly 380 are coupled to the output interface 378 and the return light signal arising from backscattering and reflections along the optical fiber 320 is coupled to the detection assembly 390.

As illustrated in FIG. 3C, the detection assembly 390 may include a light detector 394 (e.g., a photodiode, an avalanche photodiode, or any other suitable photodetector) that detects the return light signal corresponding to each test light pulse and an analog-to-digital converter 392 to convert the electrical signal proportional to the detected return light signal from analog to digital in order to allow data storage and processing. In some embodiments, the detected return light signal may be amplified, filtered, or otherwise processed before analog to digital conversion. The power level of returning light signals as a function of time (e.g., which is obtained from the detection and conversion described above) may be referred to as one acquisition of an OTDR trace. In the context of OTDR, each light acquisition may involve propagating a large number of substantially identical light pulses in the optical fiber 320 and averaging the results in order to improve the signal-to-noise ratio (SNR). In such cases, the result obtained from averaging may represent an OTDR trace.

The OTDR acquisition device 308, and more specifically the light generating assembly 380, may be controlled by the controller 372. The controller 372 may include a hardware logic device. As such, the controller 372 may include one or more field programmable gate array (FPGAs), one or more application specific integrated circuits (ASICs), or one or more processors configured with a state machine or stored program instructions. When the OTDR acquisition device 308 is in operation, the controller 372 may be configured to control the OTDR measurement process. The controller 372 may control parameters of the light generating assembly 380 according to OTDR acquisition parameters that are either provided by the operator of the OTDR software or otherwise determined by program(s) 366.

The data store 374 may be used to accumulate raw data received from the detection assembly 390, as well as intermediary averaged results and resulting OTDR traces. The data store 374 may include any volatile memory elements (e.g., RAM). Further, the data store 374 may be embedded with or separate from the controller 372. The OTDR traces acquired by the OTDR acquisition device 308 may be received and analyzed by one or more of the computer programs 366 and/or stored in data store 358 for future processing.

The architecture of the OTDR acquisition device 308 is provided solely as an example. Numerous types of optical and electronic components are available and can be used to implement the OTDR acquisition device 308 in alternative embodiments.

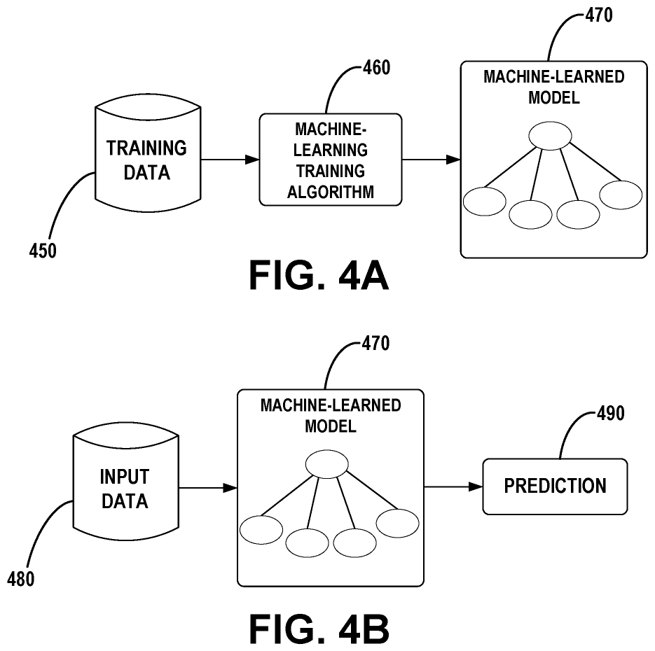

FIG. 4A illustrates a method of training a machine-learned model 470 (e.g., an artificial neural network (ANN), such as a deep ANN or a convolutional ANN; a generative adversarial network (GAN); or a support vector machine), according to example embodiments. The method of FIG. 4A may be performed by a computing device (e.g., the computing device 100 illustrated in FIG. 1), in some embodiments. As illustrated, the machine-learned model 470 may be trained using a machine-learning training algorithm 460 based on training data 450 (e.g., based on patterns within the training data 450). While only one machine-learned model 470 is illustrated in FIGS. 4A and 4B, it is understood that multiple machine-learned models could be trained simultaneously and/or sequentially and used to perform the predictions described herein. For example, in the case of a GAN, one or more generators and one or more discriminators could be simultaneously trained. Ultimately, a prediction 490 may be made using the trained machine-learned model 470.

The machine-learned model 470 may include, but is not limited to: one or more ANNs (e.g., one or more convolutional ANNs, one or more recurrent ANNs, one or more Bayesian networks, one or more hidden Markov models, one or more Markov decision processes, one or more logistic regression functions, one or more suitable statistical machine-learning algorithms, one or more heuristic machine-learning systems, one or more GANs, etc.), one or more support vector machines, one or more regression trees, one or more ensembles of regression trees (i.e., regression forests), one or more decision trees, one or more ensembles of decision trees (i.e., decision forests), and/or some other machine-learning model architecture or combination of architectures.

The machine-learning training algorithm 460 may involve supervised learning, semi-supervised learning, reinforcement learning, and/or unsupervised learning. Similarly, the training data 450 may include labeled training data and/or unlabeled training data. Further, as described above with respect to the machine-learned model 470, a number of different machine-learning training algorithms 460 could be employed herein. If the machine-learned model 470 includes a GAN, the machine-learning training algorithm 460 may include training one or more discriminator ANNs and one or more generator ANNs based on the training data 450.

Additionally, the machine-learning training algorithm 460 may be tailored and/or altered based on the machine-learned model 470 to be generated (e.g., based on desired characteristics of the output machine-learned model 470). Further, the training data 450 may be used to train the machine-learned model 470 using the machine-learning training algorithm 460. For example, the machine-learned model 470 may embed labeled training data that is used to train the machine-learned model 470. For instance, training discriminator(s)/generator(s) may occur in a supervised fashion using labeled training data and/or using sample input training data for the generator(s). Further, in some embodiments, the machine-learning training algorithm 460 may enforce rules during the training of the machine-learned model 470 through the use of one or more hyperparameters.

Once the machine-learned model 470 is trained by the machine-learning training algorithm 460 (e.g., using the method of FIG. 4A), the machine-learned model 470 may be used to make one or more predictions (i.e., inferences). For example, a computing device (e.g., the computing device 100 shown and described with reference to FIG. 1), may make a prediction 490 using the machine-learned model 470 based on input data 480, as illustrated in FIG. 4B.

The training data 450 used to train a machine-learned model 470 as described herein may include, as an input, a series of previously captured OTDR traces (e.g., with associated metadata characterizing the testing conditions under which the OTDR traces were obtained), a series of previously captured fiber inspection images (e.g., with associated metadata characterizing the testing conditions under which the fiber inspection images were obtained), synthetically generated or altered OTDR traces (e.g., with synthetically generated or altered associated metadata), synthetically generated or altered fiber inspection images (e.g., with synthetically generated or altered associated metadata), and/or synthetically generated or altered OLTS data (e.g., with synthetically generated or altered associated metadata). Likewise, as outputs, the training data 450 may include a binary indication of whether two inputs represent duplicated (e.g., inappropriately repeated) tests of the same optical fiber. Alternatively, the training data 450 may include a decimal value (e.g., from 0 to 1) indicative of the degree to which the two inputs represent duplicated tests of the same optical fiber. Ultimately, one example of a machine-learned model 470 described herein (e.g., as shown and described below as machine-learned model 820) may be configured to generate embedding vectors for fiber characterization data (e.g., OTDR traces, fiber inspection images, and/or OLTS data) that can be compared to one another as part of a determination of whether duplicated (e.g., inappropriately repeated) optical fiber tests have occurred.

Additionally or alternatively, in some embodiments, machine-learned models 470 described herein may be continuously updated as they are used. For example, upon additional OTDR traces being captured and processed by an OTDR device (e.g., the OTDR device 302 shown and described with reference to FIGS. 3A and 3B), the machine-learned model 470 may be re-trained using the additional OTDR traces as new training data 450 (e.g., in addition to the previously used training data 450). Such additional training may be performed by the same computing device that initially trained the machine-learned model 470 or by a separate computing device (e.g., a server device, a cloud device, a mobile device, a tablet device, etc.).

While the same computing device (e.g., a computing device 100 as in FIG. 1) may be used to both train the machine-learned model 470 (e.g., as illustrated in FIG. 4A) and make use of the machine-learned model 470 to make a prediction 490 (e.g., as illustrated in FIG. 4B), it is understood that this need not be the case. In some embodiments, for example, a computing device may execute the machine-learning training algorithm 460 to train the machine-learned model 470 and may then transmit the machine-learned model 470 to another computing device for use in making one or more predictions 490. In the context of this disclosure, for example, a computing device may be used to initially train the machine-learned model 470 and then this machine-learned model 470 could be stored for later use.

FIG. 5A is a plot of an OTDR trace 502, according to example embodiments. For example, the OTDR trace 502 may have been generated and/or displayed by the device 302 (e.g., using the OTDR acquisition device 308). Additionally, in some embodiments, the OTDR trace 502 may be stored in a memory, such as a memory of a server device (e.g., a server device used to host an optical fiber testing platform) for subsequent processing.

As illustrated in FIG. 5A, the OTDR trace 502 may be a plot of optical power level (e.g., measured in dB) with respect to the distance along an optical fiber under test (e.g., measured in m). As noted above, the OTDR trace 502 may be a representation of an intensity of backscatter and reflections measured during one or more OTDR acquisitions. Peaks or spikes of optical power level (e.g., similar to the peak at about 8000 m illustrated in FIG. 5A) may be indicative of one type of feature along an optical fiber under test (e.g., an optical-fiber connector). Likewise, drops in optical power level (e.g., similar to the drop at about 14000 m illustrated in FIG. 5A) may be indicative of a second type of feature along an optical fiber under test (e.g., a splice). It is understood that the optical power levels and distances illustrated in the OTDR trace 502 of FIG. 5A are provided solely as examples and other optical power levels and/or distances are also possible. The OTDR trace 502 may be an example of fiber characterization data generated based on an optical fiber test. Further, according to techniques described herein, the OTDR trace 502 (e.g., and associated metadata characterizing the testing conditions under which the OTDR trace 502 was obtained) may be used, in conjunction with one or more other OTDR traces 502 (e.g., and associated metadata characterizing the testing conditions under which the OTDR trace 502 was obtained), in order to determine whether duplicated optical fiber tests have been performed.

FIG. 5B is an illustration of a fiber inspection image 504, according to example embodiments. For example, the fiber inspection image 504 may have been generated and/or displayed by the device 302 (e.g., using the fiber inspection probe 322). Additionally, in some embodiments, the fiber inspection image 504 may be stored in a memory, such as a memory of a server device (e.g., a server device used to host an optical fiber testing platform) for subsequent processing. As illustrated in FIG. 5B, the fiber inspection image 504 may include (e.g., at the bottom of the image) associated metadata characterizing the testing conditions under which the fiber inspection image 504 was obtained (i.e., metadata about an associated optical fiber test). It is understood that the location of the metadata within the fiber inspection image 504 and the type of metadata included in the fiber inspection image 504 is provided solely as an example and that other locations and types of metadata are also possible. In some embodiments, for example, metadata may simply be retained (e.g., associated in memory) with the fiber inspection image 504 and not included in the fiber inspection image 504 itself.

As illustrated, the fiber inspection image 504 may include an image (e.g., cross-sectional image) of an optical fiber under test. For example, the fiber inspection image 504 may be an optical-fiber connector endface inspection image. In some embodiments, the fiber inspection image 504 may include an image of a core of the optical fiber under test, one or more claddings of the optical fiber under test, one or more coatings of the optical fiber, and/or one or more jackets of the optical fiber. In some embodiments, for example, one or more fingerprints of a cladding layer of optical fiber(s) under test may assist in determining whether duplicated (e.g., inappropriately replicated) optical fiber tests are being performed. This cladding layer may be used to identify duplicated optical fiber tests even if the optical fiber under duplicated test has been cleaned between optical fiber tests.

Like the OTDR trace 502 of FIG. 5A, the fiber inspection image 504 of FIG. 5B may be fiber characterization data used to identify duplicated (e.g., inappropriately replicated) optical fiber tests. Further, as described herein, an embedding vector may be generated using the fiber inspection image 504. In some embodiments, and by including coating(s); jacket(s); an external environment of the fiber; etc., embedding vector(s) generated using the fiber inspection image 504 may also incorporate any regions of interest (e.g., artifacts) that are located outside of the cladding layer of the optical fiber under test. This may also provide information used to identify duplicated optical fiber tests. For example, if a smudge or defect is common across two separate fiber inspection images or if the epoxy/adhesive used for an optical fiber under test dried in a specific way, the embedding vector(s) may be used to identify these unique characteristics duplicated among multiple fiber inspection images. As illustrated, various regions of interest 506 (i.e., keypoints) may be identified (e.g., by a computing device) within the fiber inspection image 504. In some embodiments, identifying the regions of interest 506 may involve applying a machine-learned model that is trained to identify aberrations or non-uniformities to the fiber inspection image 504. The regions of interest 506 may result from optical aberrations (e.g., associated with a fiber inspection probe used to capture the fiber inspection image 504), from defects within the optical fiber under test, and/or from debris present on the fiber inspection probe at the time the fiber inspection image 504 was captured. Further, identified regions of interest 506 in separate fiber inspection images can be compared with one another to determine whether an optical fiber test has been duplicated. For example, localized embedding vectors may be generated for each of the respective regions of interest 506 in a first fiber inspection image 504 and separate localized embedding vectors may be generated for each of the respective regions of interest 506 in a second fiber inspection image 504. These embedding vectors may then be compared with one another in various ways (e.g., by counting the total number of regions of interest, by comparing the respective multidimensional values in each of the localized embedding vectors, by determining a weighted average based on various dimensions of the localized embedding vectors for each of the respective fiber inspection images 504, by comparing the x-y locations of the respective regions of interest 506 within the respective fiber inspection images 504, etc.) in order to determine a similarity score between the two optical fiber tests.

As described herein, metadata may be used in conjunction with fiber characterization data to identify duplicated optical fiber tests. As described herein, temporal characteristics of a series of optical fiber tests may be considered when attempting to determine whether one or more of the optical fiber tests was duplicated. As mentioned above, two separate, but clean, optical fibers can be difficult to evaluate for duplicated optical fiber tests based purely on the fiber characterization data alone. Hence, in the absence of the testing condition evaluation techniques described herein (e.g., if relying purely on the comparison of fiber characterization data), false positives could occur. For instance, two sets of fiber characterization data could appear to be captured from the same optical fiber even when captured from two different optical fibers because the two different optical fibers have been manufactured in the same way and with high precision.

Hence, in order to account for this, testing condition scores are used in conjunction with similarity scores herein in order to identify duplicated optical fiber tests. The testing condition score (e.g., based on factors taken from metadata associated with fiber characterization data) may be used to analyze factors like the rate of subsequent optical fiber tests, how much time technicians have spent before running new subsequent optical fiber tests, etc. For example, subsequent optical fiber tests within a testing job may be highlighted. Thereafter, factors like the average test time for the optical fiber tests that are highlighted may be evaluated against a threshold rate. For example, an OTDR measurement (e.g., an example optical fiber test) may take about 15 seconds per wavelength to complete. Further, in many optical fiber tests, more than one wavelength may be tested. So, a technician may need at least 30 seconds per optical fiber test to adequately perform the OTDR acquisition. If, however, optical fiber tests are repeatedly captured at a test rate that is greater than a predicted test rate (e.g., at a rate of more than one OTDR acquisition per 30 seconds), this may be an indication of duplicated optical fiber tests (e.g., resulting in a higher testing condition score, as described herein). Other factors such as the amount of setup time between optical fiber tests and/or the geographic location of subsequent tests (e.g., based on the difference between a first testing location and a second testing location contained within metadata associated with fiber characterization data) may be considered. For instance, if subsequent optical fiber tests are conducted in quick succession in a single geographic location, this may be an indication of duplicated optical fiber tests. Additionally or alternatively, the order in which different types of optical fiber tests are conducted may be indicative of potential duplicated optical fiber tests. For example, repeated optical fiber tests of the same type may increase the likelihood of duplicated optical fiber tests. For example, if a prescribed sequence of optical fiber tests for a given fiber involves performing a test using a fiber inspection probe followed by a test using an OTDR device, observing repeated fiber inspection probe test results without corresponding OTDR test results (or vice versa) may indicate a deviation from the prescribed sequence (e.g., resulting in an increased testing condition score, as described herein). Time stamps can be used to evaluate the sequence in which various types of optical fiber tests were performed.

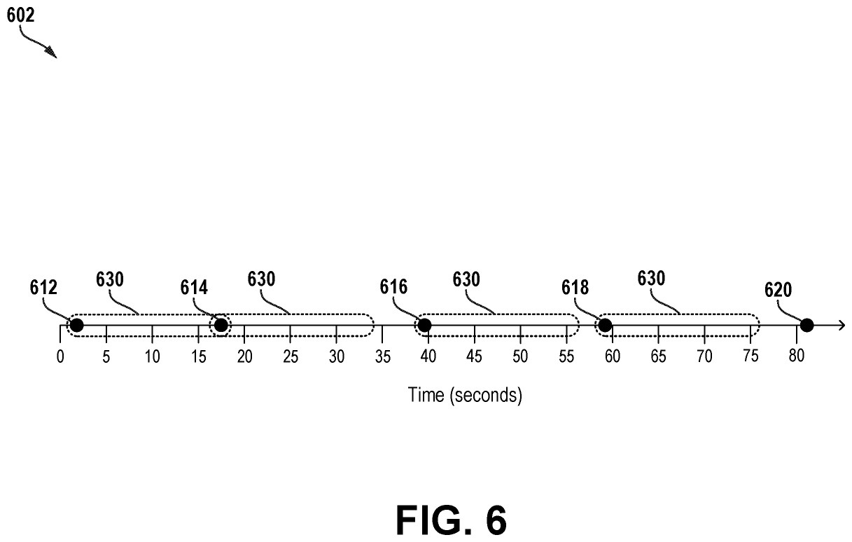

As an example, FIG. 6 is a timing diagram 602 illustrating timings (e.g., based on metadata associated with fiber characterization data) associated with multiple optical fiber tests 612, 614, 616, 618, 620. For example, the timing diagram 602 shows the start time (i.e., “testing time”) in seconds of each of five optical fiber tests 612, 614, 616, 618, 620. As illustrated, optical fiber test 612 starts at 2 seconds, optical fiber test 614 starts at 17 seconds, optical fiber test 616 starts at 39 seconds, optical fiber test 618 starts at 59 seconds, and optical fiber test 620 starts at 81 seconds. Because the timing of optical fiber tests may be indicative of duplicated optical fiber tests, this information may be used to identify potentially inappropriately replicated optical fiber tests. For example, if two optical fiber tests are executed in quick succession (e.g., at a sufficiently high testing rate), it may be an indication that the same optical fiber is being retested (e.g., rather than swapping the testing equipment to a subsequent optical fiber for testing, even when the technician purports to have swapped the testing equipment to a subsequent optical fiber). In some cases, for instance, when the start time of subsequent optical fiber tests are separated by less than a threshold time, it may be an indication that the second optical fiber test is actually a duplicate of the first optical fiber test (i.e., the same optical fiber is being tested twice).

In FIG. 6, timing thresholds 630 are indicated. The timing thresholds 630, for example, may correspond to 18 seconds between the start of optical fiber tests. Any subsequent optical fiber tests that are within the threshold (i.e., correspond to less than a threshold separation in time after the previous optical fiber test) may be flagged as potential duplicated tests. As illustrated in FIG. 6, optical fiber test 614 may be a duplicate test of optical fiber test 612 because the start of optical fiber test 614 is separated from the start of optical fiber test 612 by less than the timing threshold 630. However, optical fiber test 616, optical fiber test 618, and optical fiber test 620 may not be flagged as potential duplicated tests because each of optical fiber tests 616, 618, 620 does not have a start time that is separated from a previous optical fiber test by less than the timing threshold 630.

As described herein, in some embodiments, upon being flagged as a potential duplicated test based on the timing of the start of optical fiber test 614, optical fiber test 614 may be compared in additional ways to optical fiber test 612 to confirm whether optical fiber test 614 does, in fact, represent a duplicated optical fiber test. For example, an embedding vector of optical fiber test 614 generated based on fiber characterization data of optical fiber test 614 (e.g., generated by a machine-learned model) may be compared to an embedding vector of optical fiber test 612 generated based on fiber characterization data of optical fiber test 612 (e.g., generated by a machine-learned model) to determine a similarity score between optical fiber test 612 and optical fiber test 614. The similarity score may then be used to evaluate whether optical fiber test 612 and optical fiber test 614 are sufficiently similar so as to constitute duplicate optical fiber tests.

It is understood that the timing thresholds 630 illustrated in FIG. 6 are provided solely as examples. Different timing thresholds (e.g., longer or shorter timing thresholds) are also possible. In some embodiments, the timing thresholds used to identify potential duplicate tests may be determined based on a testing rate that exceeds 90%, 95%, 99%, or 99.9% of testing rates across optical fiber tests within an associated testing dataset (e.g., a dataset of all optical fiber tests within a given testing job or of all optical fiber tests across an entire network). Additionally or alternatively, in some embodiments, a user selection of a value for the timing threshold may be received (e.g., by a computing device, such as the device 302 shown and described with reference to FIG. 3A). This user selection may be used to establish the timing threshold.

Further, comparing the start times of various optical fiber tests is only one example metadata analysis used to identify potentially duplicated optical fiber tests. However, other metadata analyses (including other timing analyses) are also possible. For example, rather than comparing the start times between adjacent optical fiber tests to a threshold, the difference between the end time of a first optical fiber test and a start time of a second optical fiber test may be compared to a threshold (e.g., to evaluate the alleged setup time for the second optical fiber test). Such a threshold, for example, may be determined based on a test setup time that is less than 90%, 95%, 99%, or 99.9% of test setup times across the optical fiber tests within an associated testing dataset (e.g., a dataset of all optical fiber tests within a given testing job or of all optical fiber tests across an entire network).

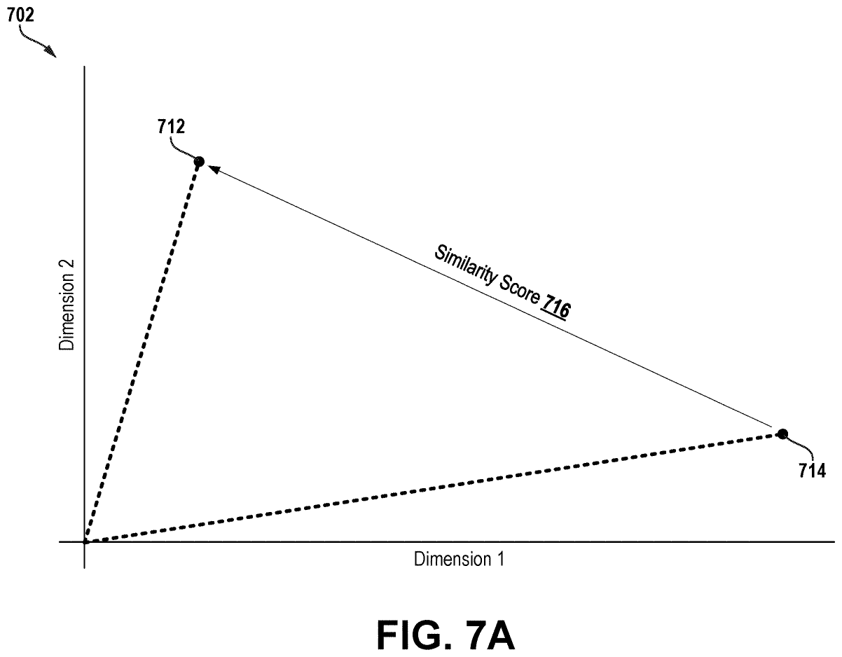

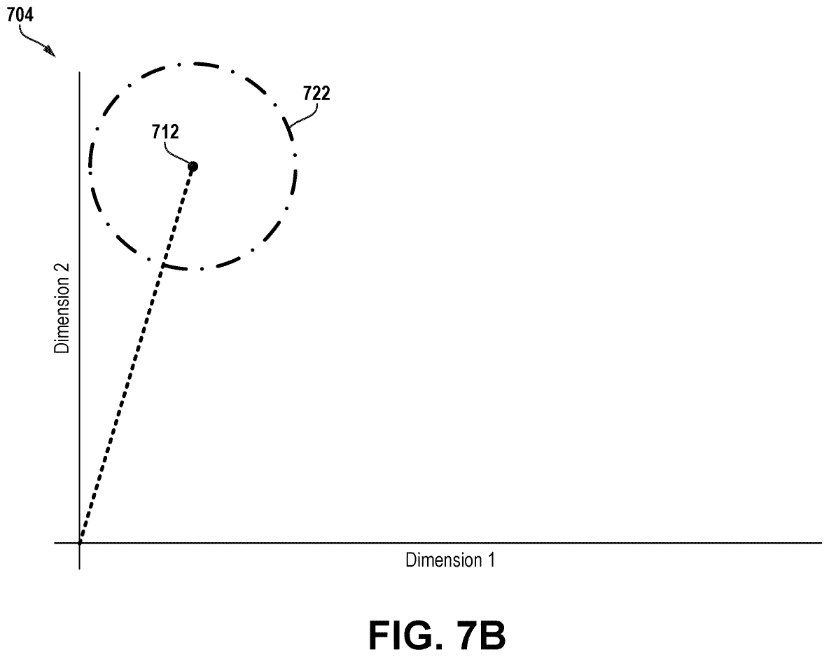

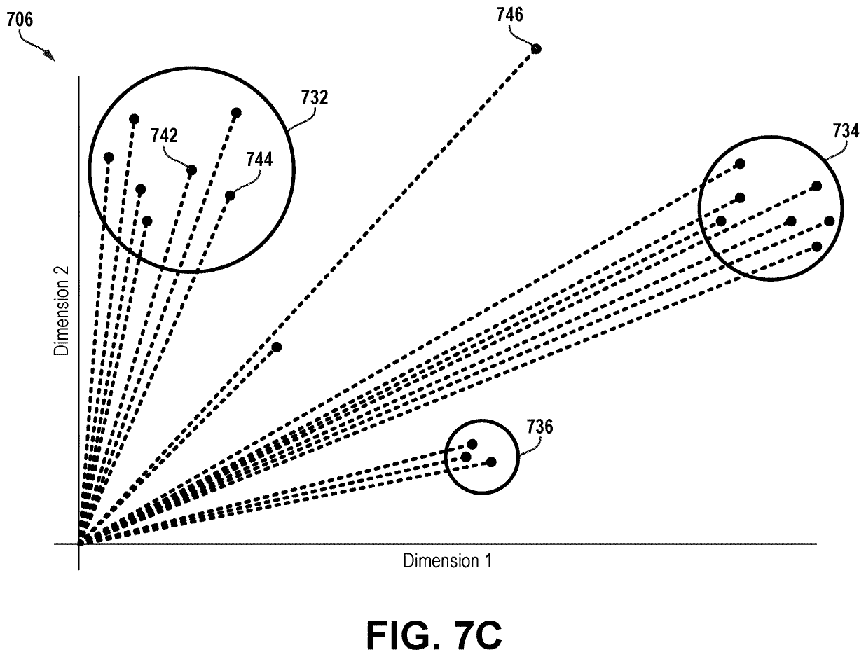

FIG. 7A is a plot 702 illustrating embedding vectors 712, 714 and a similarity score 716, according to example embodiments. As described herein, in conjunction with a testing condition score (e.g., used to identify factors indicative of duplicated optical fiber tests like separations between successive testing times and separations between successive testing locations), fiber characterization data may be evaluated to compare the similarities between the optical fibers under test across multiple optical fiber tests. For example, a machine-learned model may be used to generate embedding vectors for fiber characterization data of each of the optical fiber tests being evaluated. For instance, as illustrated in FIG. 7A, a first embedding vector 712 may be generated for first fiber characterization data (e.g., a first fiber inspection image, a first OTDR trace, or first OLTS data) and a second embedding vector 714 may be generated for second fiber characterization data (e.g., a second fiber inspection image, a second OTDR trace, or second OLTS data).

An “embedding vector” may be a numerical representation of an object that machine-learning systems use to quantify complex knowledge domains. For example, machine-learned models (e.g., ANNs) may convert objects like text, images, audio, and tests results, into vectors in a multidimensional continuous vector space that capture inherent properties and relationships. While the dimensions in such a multidimensional continuous vector space might correspond to human-interpretable features (e.g., color, brightness, size, etc.) of the object from which the embedding vector was derived, the dimensions need not. In some embodiments, for example, the dimensions may correspond to superpositions of human-interpretable features.

By comparing two embedding vectors (e.g., the first embedding vector 712 and the second embedding vector 714), a similarity score (e.g., the similarity score 716) may be determined. For example, a Euclidean distance may be determined between two embedding vectors, with a smaller distance corresponding to an increased similarity. For example, the Euclidean distance between the first embedding vector 712 and the second embedding vector 714 illustrated in FIG. 7A may be calculated by determining the square root of the sum of the squares of the distances between the two embedding vectors 712, 714 in all dimensions. Assuming the first embedding vector 712 has a value along dimension 1 of X₁ and a value along dimension 2 of Y₁, and the second embedding vector 712 has a value along dimension 1 of X₂ and a value along dimension 2 of Y₂, the Euclidean distance (e.g., used to calculate the similarity score 716) may be determined according to the following formula:
Euclidean Distance=\sqrt{(X₂−X₁)²+(Y₂−Y₁)²}

While only two dimensions are illustrated in FIG. 7A and used to define the embedding vectors 712, 714, it is understood that this is provided solely for illustrative purposes and that other numbers of dimensions are also possible. For example, depending on the machine-learned model used to generate the embedding vectors 712, 714 (e.g., based on fiber characterization data), the numbers of dimensions used to define for each embedding vector 712, 714 may be three, four, five, six, seven, eight, nine, ten, twenty five, fifty, one hundred, five hundred, one thousand, etc. Any number of dimensions for the embedding vectors 712, 714 are possible. Additionally, in some embodiments, the number of dimensions used to define the embedding vectors 712, 714 may be set based on a machine-learning training algorithm used to train the machine-learned model used to generate the embedding vectors 712, 714 (e.g., based on the fiber characterization data). While Euclidean distance represents one possible type of similarity score, it is understood that other types of similarity scores are possible, as well (e.g., similarities based on the angle between two embedding vectors, such as a cosine similarity). Even further, in some embodiments, the similarity score between two sets of fiber characterization data may be determined based on factors other than embedding vectors (e.g., mean image intensity across the entirety of a fiber inspection image).

As described above, similarity scores may be determined based on embedding vectors determined for sets of fiber characterization data (e.g., fiber inspection images). In some embodiments, this may involve using a machine-learned model to process an entire fiber inspection image (e.g., the fiber inspection image 504 shown and described with reference to FIG. 5B). However, in some embodiments, embedding vectors may also be determined for one or more portions of a fiber inspection image. For example, embedding vectors may be determined for each of the regions of interest 506 shown and described with reference to FIG. 5B (as opposed to an embedding vector being generated for the entire fiber inspection image 504). The embedding vectors determined for the regions of interest 506 in fiber inspection images 504 corresponding to different optical fiber tests may then be compared to one another to determine a similarity score (e.g., a similarity score used to determine whether duplicated optical fiber tests have been performed). For example, in some embodiments, the number of regions of interest 506, the values of dimensions in the embedding vectors for the regions of interest 506, or the locations of the regions of interest 506 (e.g., x-y locations within the fiber inspection image 504) may be compared to determine a similarity score. In some embodiments, for instance, a weighted average of a subset (e.g., all) of the dimensions of the embedding vectors for a subset (e.g., all) of the regions of interest 506 in a first fiber inspection image 504 (e.g., α·region_of_interest_1_{dimension1}+β·region_of_interest_1_{dimension2}+γ·region_of _interest_2_{dimension1}+ . . . , where α, β, and γ are the weights) may be compared to the weighted average of a subset (e.g., all) of the dimensions of the embedding vectors for a subset (e.g., all) of the regions of interest 506 in a second fiber inspection image 504 (e.g., α·region_of_interest_1_{dimension1}+β·region_of_interest_1_{dimension2}+γ·region_of_interest_2_{dimension1}+ . . . , where α, β, and γ are the weights) to determine a similarity score. Further, in some embodiments, one or more statistical measures may be determined based on embedding vectors related to corresponding regions of interest 506 across multiple fiber inspection images 504. For instance, Euclidean distances between corresponding embedding vectors (e.g., embedding vectors that correspond to similar regions of interest 506) may be determined and then a minimum, maximum, mean, median, etc. metric may be calculated using the determined Euclidean distances in order to generate a similarity score.

Additionally or alternatively, in some embodiments, the embedding vectors for the respective regions of interest 506 of the two fiber inspection images 504 may be provided (e.g., along with metadata associated with the fiber inspection images 504, themselves) to an additional machine-learned model (e.g., a random forest, a deep ANN, or a convolutional ANN). The additional machine-learned model may have been trained to determine a similarity score based on the various inputs. For example, the machine-learned model may have been trained using, as labeled training data: (i) regions of interest in images corresponding to pairs of duplicated optical fiber tests and (ii) regions of interest in images corresponding to pairs of non-duplicated optical fiber tests. In other embodiments, the machine-learned model may be trained using unlabeled training data (e.g., an unsupervised machine-learning model may be used to identify regions of interest or keypoints within training fiber inspection images and those identified regions of interest and/or keypoints may be used to train the machine-learned model). Additionally or alternative, the machine-learned model may be trained to produce a continuous similarity score (e.g., between 0 and 1), with the determination of duplicated/non-duplicated optical fiber tests being based on a comparison to a similarity score threshold. In such cases, the similarity score may identify a confidence level associated with the duplicated/non-duplicated optical fiber test determination. For example, a similarity score threshold of 0.5 may be used to identify duplicated optical fiber tests (e.g., with similarity scores greater than or equal to 0.5 representing duplicated optical fiber tests and similarity scores less than 0.5 corresponding to non-duplicated optical fiber tests) and similarity scores between 0 and 0.25 and between 0.75 and 1 may correspond to determinations made with higher confidence than similarity scores between 0.25 and 0.75.

In addition to or instead of comparing embedding vectors from portions of one fiber inspection image (e.g., regions of interest) to embedding vectors from portions of another fiber inspection image (e.g., regions of interest), determining a similarity score may include determining a global similarity (e.g., between an embedding vector representing the entirety of one fiber inspection image and an embedding vector representing the entirety of another fiber inspection image). Determining such a global similarity may include dimensionality reduction (e.g., using principal component analysis (PCA) or by determining one or more summarizing statistics between the embedding vectors).

Additionally or alternatively, determining the similarity score may involve a combination of the techniques described herein. For example, to determine a similarity score between two fiber inspection images, a subscore based on a global similarity between the two fiber inspection images, a subscore based on Euclidean distance(s) between embedding vectors that correspond to similar regions of interest 506, subscores determined based on metadata associated with the optical fiber tests associated with the fiber inspection images, or other subscores may be combined to produce a final similarity score. In such a combination, some subscores may be weighted more strongly than other subscores (e.g., as a form of dimensionality reduction). Further, in some embodiments, calculating the final similarity score based on subscores may involve providing the subscores to a machine-learned model trained to determine similarity scores for optical fiber test comparisons based on similarity subscores.

Still other techniques for determining a similarity score between fiber characterization data (e.g., fiber inspection images or OTDR traces) are also possible. For example, in some embodiments, a similarity score may be determined using a combination of embedding vectors (e.g., including compressed and/or transformed forms of the embedding vectors) generated for the regions of interest 506 in a fiber inspection image 504 and an embedding vector generated for the entire fiber inspection image 504 (e.g., where the embedding vectors generated for the regions of interest 506 and the embedding vector generated for the entire fiber inspection image 504 are generated using the same or different machine-learned models). For instance, a machine-learned model may be trained to determine a similarity score based on a weighted average of: (i) Euclidean distances between the embedding vectors of corresponding regions of interest 504 among different fiber inspection images of two different optical fiber tests and (ii) the Euclidean distance between the embedding vectors of the fiber inspection image 504 of the first optical fiber test and the fiber inspection image 504 of the second optical fiber test (e.g., where the Euclidean distance of the latter is weighted more heavily than the Euclidean distances of the former). Additionally or alternatively, distance metrics between embedding vectors generated for regions of interest 506, statistics based on embedding vectors generated for regions of interest 506 (e.g., logarithmic distance between, minimum distance between, maximum distance between, mean distance between, median distance between, etc.), and/or dimensionality reduced representations of embedding vectors generated for regions of interest 506 (e.g., determined using PCA or an autoencoder) may be used in the determination of a similarity score. Even yet other techniques for determining a similarity score are also possible.

Once a similarity score is determined (e.g., by determining the Euclidean distance between the first embedding vector 712 and the second embedding vector 714), the similarity score may be compared to a threshold similarity score in order to determine whether the two optical fiber tests (e.g., a first optical fiber test upon which the first embedding vector 712 was based and a second optical fiber test upon which the second embedding vector 714 was based) constitute duplicated optical fiber tests. For example, upon determining the Euclidean distance between the first embedding vector 712 and the second embedding vector 714 to determine the similarity score 716, the Euclidean distance may be compared to a threshold distance. If the Euclidean distance is less than or equal to the threshold distance, the first optical fiber test and the second optical fiber test may be determined to be sufficiently similar so as to constitute duplicated optical fiber tests (e.g., so long as the testing condition score between the first optical fiber test and the second optical fiber test based on associated metadata also satisfies criteria sufficient to constitute duplicated optical fiber tests).

FIG. 7B is a plot 704 illustrating an embedding vector (e.g., the first embedding vector 712 shown and described with reference to FIG. 7A) and a related threshold distance 722. As described above, if an additional embedding vector is separated from the first embedding vector 712 by less than the threshold distance 722, the first embedding vector 712 and the additional embedding vector may be similar enough to constitute duplicated optical fiber tests. Hence, any additional embedding vectors that lie within or on the circle denoting the threshold distance 722 in FIG. 7B may be sufficiently similar so as to constitute duplicated optical fiber tests and any additional embedding vectors that lie outside the circle denoting the threshold distance 722 in FIG. 7B may be sufficiently different so as not to constitute duplicated optical fiber tests.

The threshold distance 722 may be determined based on a machine-learned model (e.g., the machine-learned model used to generate the embedding for the first embedding vector 712). In some embodiments, the threshold distance 722 may be determined based on a user selection. Further, it is understood that other threshold distances are also possible and that FIG. 7B is provided solely as an example. Further, in embodiments where the embedding vectors have more than two dimensions, the shape representing the threshold distance 722 may also have more than two dimensions (e.g., the threshold distance 722 may be represented by a sphere, a four-dimensional object, a five-dimensional object, etc.). Additionally or alternatively, an anisotropic threshold distance may be used in some embodiments. Notably, the threshold distance 722 illustrated in FIG. 7B is isotropic relative to dimension 1 and dimension 2, which is why the threshold distance 722 is illustrated as a circle. In other embodiments, though, the threshold may be weighted more heavily in some dimensions (e.g., the contribution of the difference between two embedding vectors in a first dimension may be greater than the contribution of the difference between two embedding vectors in a second dimension when it comes to determining a similarity score for the purpose of duplicate optical fiber test identification). For example, if, when it comes to identifying similarity for the purpose of duplicate optical fiber test identification, the contribution of the separation between two embedding vectors along dimension 1 were more heavily weighted than the contribution of the separation between two embedding vectors along dimension 2, the shape of the threshold distance 722 in FIG. 7B may be an ellipse instead of a circle (e.g., with the minor axis of the ellipse along dimension 1 being shorter than the major axis of the ellipse along dimension 2). In still other embodiments, similarity thresholds (e.g., threshold distances) may be determined (e.g., dynamically during testing) using clustering techniques. For example, clustering techniques may be applied to sets of fiber characterization data (e.g., synthetic sets of fiber characterization data) known to be similar to one another and sets of fiber characterization data (e.g., synthetic sets of fiber characterization data) known to be dissimilar from one another in order to define similarity thresholds. Using clustering techniques to define similarity thresholds may maximize inter-cluster separation and/or improve the robustness of duplicate detection.

In some embodiments, rather than comparing only two optical fiber tests (e.g., based on two sets of fiber characterization data, each with associated metadata) to one another to identify potential duplicated optical fiber tests, three or more optical fiber tests may be considered at a time. Doing so may save computing resources (e.g., processor cycles and/or transactions with a memory storing data related to the optical fiber tests) by reducing the number of comparisons required to identify duplicated optical fiber tests. Additionally or alternatively, in order to compare two or more embedding vectors associated with two or more respective optical fiber tests, one or more clustering techniques may be performed. Clustering techniques may be used to identify when embedding vectors are part of a common cluster (e.g., in order to identify embedding vectors that are similar to one another).

FIG. 7C is a plot 706 illustrating a number of embedding vectors and associated clusters, according to example embodiments. For example, as illustrated, the plot 706 includes a first embedding vector 742 corresponding to a first optical fiber test (e.g., and determined based on fiber characterization data of the first optical fiber test) and a second embedding vector 744 corresponding to a second optical fiber test (e.g., and determined based on fiber characterization data of the second optical fiber test). As illustrated, the first embedding vector 742 and the second embedding vector 744 are members of a first cluster 732. Other embedding vectors are members of other clusters (e.g., a second cluster 734 and a third cluster 736). As illustrated, the clusters 732, 734, 736 might not be the same size as one another. Further, in some embodiments, clusters might not be the same multidimensional shape as one another. Additionally, some embedding vectors may not be members of any cluster and/or may be the only member of a given cluster (e.g., when the embedding vectors are sufficiently disparate from all other embedding vectors produced within a dataset). For example, the third embedding vector 746 illustrated in FIG. 7C is not a member of cluster 732, cluster 734, or cluster 736. It is understood that, to avoid cluttering the drawing, embedding vectors other than the first embedding vector 742, the second embedding vector 744, and the third embedding vector 746 are not labeled in FIG. 7C with reference numerals.

In various embodiments, clusters may be determined prior to, after, and/or as part of determining the similarity score for two or more embedding vectors corresponding to two or more respective optical fiber tests. For example, comparing the first embedding vector 742 to the second embedding vector 744 to determine a similarity score may include determining, based on a clustering technique, that the first embedding vector 742 and the second embedding vector 744 are members of a common cluster (e.g., cluster 732). Further, determining that the first embedding vector 742 and the second embedding vector 744 are members of a common cluster (e.g., cluster 732) may include determining a Euclidean distance between the first embedding vector and the second embedding vector and comparing the Euclidean distance to a threshold distance (e.g., a threshold distance determined based on Euclidean distances between sample embedding vectors determined using the machine-learned model, wherein the sample embedding vectors correspond to labelled embedding vectors that represent duplicate optical fiber tests and labelled embedding vectors that represent non-duplicated optical fiber tests). Various clustering techniques may be used in various embodiments. For example, in some embodiments, graph clustering techniques or a k-means clustering techniques may be used. Further, the parameters of the one or more clustering techniques used may be modified (e.g., based on one or more user selections) to accommodate specific types of optical fibers, optical fiber connectors, optical fiber measurement techniques, etc.

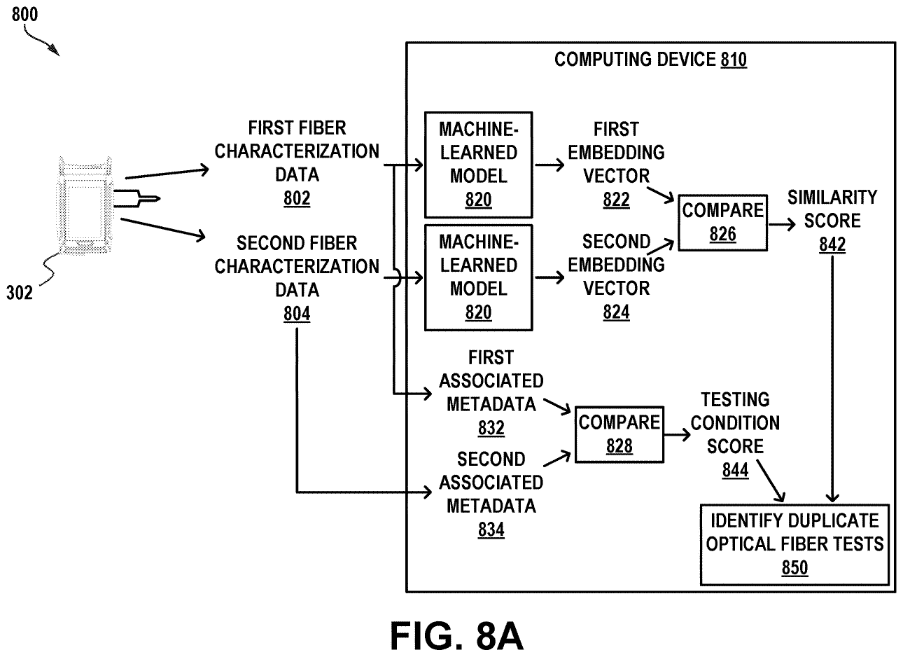

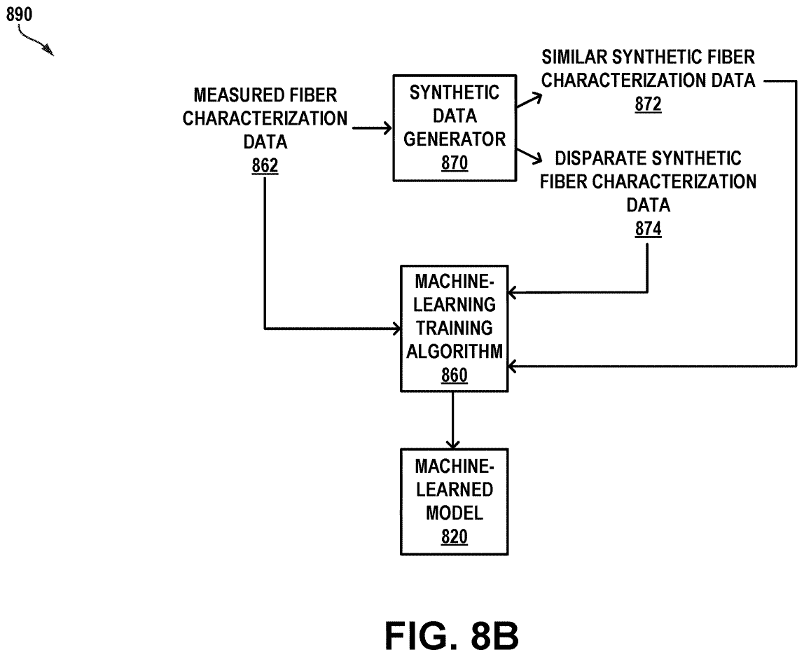

FIG. 8A is a block diagram of a technique 800 for identifying duplicate optical fiber tests, according to example embodiments. As illustrated, the technique 800 may be performed using a device (e.g., the device 302 shown and described with reference to FIGS. 3A and 3B) and a computing device 810 (e.g., similar to the computing device 100 shown and described with reference to FIG. 1, the server cluster 200 shown and described with reference to FIG. 2, the server devices 202 shown and described with reference to FIG. 2, and/or the server 314 shown and described with reference to FIG. 3A). As shown in FIG. 8A, the technique 800 may identify duplicate optical fiber tests (e.g., and/or identify tests that are non-duplicated optical fiber tests). While the technique 800 illustrated in FIG. 8A is performed by both the device 302 and the computing device 810, it is understood that, in some embodiments, a single device may perform each of the steps illustrated in FIG. 8A. For example, the device 302 may alone perform each of the steps illustrated in FIG. 8A (e.g., using a computing device internal to the device 302).

As illustrated, the device 302 may generate two (or more) sets of fiber characterization data. For example, the device 302 may measure an optical fiber and/or associated optical fiber connector(s) to generate first fiber characterization data 802 and second fiber characterization data 804. The first fiber characterization data 802 and the second fiber characterization data 804 may be OTDR traces, fiber inspection images, or OLTS data, in various embodiments. Other types of fiber characterization data are also possible (e.g., power measurements for various channels of a DWDM channel checker; spectral profiles based on different testing wavelengths from an optical spectrum analyzer; data from a dispersion analyzer, such as chromatic dispersion measurements or polarization mode dispersion measurements; or RF spectrum data from a spectrum analyzer).

After generating the fiber characterization data 802, 804, the device 302 may provide the fiber characterization data 802, 804 (e.g., along with associated metadata) to the computing device 810. In some embodiments, the first associated metadata 832 may be embedded within (e.g., within the file structure of or displayed within an image, such as a fiber inspection image) the first fiber characterization data 802 and the second associated metadata 834 may be embedded within (e.g., within the file structure of or displayed within an image, such as a fiber inspection image) the second fiber characterization data 804. In other embodiments, the first associated metadata 832 and the second associated metadata 834 may be stored within the device 302 separate from the fiber characterization data 802, 804. In such embodiments, the associated metadata 832, 834 may be provided to the computing device 810 together with or separately from the fiber characterization data 802, 804.

Upon receiving the first fiber characterization data 802 and the second fiber characterization data 804, the computing device 810 may generate a first embedding vector 822 corresponding to the first fiber characterization data 802 and a second embedding vector 824 corresponding to the second fiber characterization data 804. The first embedding vector 822 and the second embedding vector 824 may be generated using a machine-learned model 820 (e.g., both the first embedding vector 822 and the second embedding vector 824 may be generated using the same machine-learned model 820). The machine-learned model 820 (e.g., an ANN, such as a convolutional ANN) may be trained to generate embedding vectors based on features of fiber characterization data. Further, the machine-learned model 820 may have been trained to generate similar embedding vectors for sets of fiber characterization data that correspond to duplicate optical fiber tests (e.g., by using sets of fiber characterization data generated by duplicate optical fiber tests as training data).

The first embedding vector 822 and the second embedding vector 824 may then be compared to one another (e.g., by the computing device 810) at block 826 of the technique 800. This comparison may result in a similarity score 842. For example, a Euclidean distance between the first embedding vector 822 and the second embedding vector 824 may be calculated to determine the similarity score 842.

Additionally, as illustrated in FIG. 8A, the first associated metadata 832 and the second associated metadata 834 may be compared to one another (e.g., by the computing device 810) at block 828 of the technique 800. In some embodiments, prior to comparing the first associated metadata 832 to the second associated metadata 834, the computing device 810 may extract the first associated metadata 832 from the first fiber characterization data 802 and/or extract the second associated metadata 834 from the second fiber characterization data 804. Comparing the first associated metadata 832 to the second associated metadata 834 may include determining a difference in testing start times between the first optical fiber test (characterized by the first associated metadata 832) and the second optical fiber test (characterized by the second associated metadata 834), determining differences in testing location between the first optical fiber test and the second optical fiber test based on geographic locations in the respective associated metadata 832, 834, determining a testing rate based on a start time of the first optical fiber test (characterized by the first associated metadata 832) and a start time of the second optical fiber test (characterized by the second associated metadata 834), or determining a setup time for the second optical fiber test based on an end time of the first optical fiber test (characterized by the first associated metadata 832) and a start time of the second optical fiber test (characterized by the second associated metadata 834). Other comparisons between the associated metadata 832, 834 are also possible. Based on the comparison of block 828, a testing condition score 844 may be determined.

As additionally illustrated in FIG. 8A, technique 800 may include identifying duplicate optical fiber tests (e.g., by the computing device 810) at block 850. Identifying duplicate optical fiber tests may include determining whether the testing condition score 844 satisfies a threshold testing condition score and/or determining whether the similarity score 842 satisfies a threshold similarity score. If both scores 842, 844 satisfy respective thresholds, the computing device 810 may determine that the first optical fiber test corresponding to the first fiber characterization data 802 and the second optical fiber test corresponding to the second fiber characterization data 804 are duplicated (e.g., inappropriately replicated) optical fiber tests. Additionally or alternatively, in some embodiments, one of the scores 842, 844 may be compared to a threshold and then, only if that threshold is satisfied, the other score may be compared to a different threshold. For example, the testing condition score 844 may be compared to a threshold representing testing times, testing rates, geographic separations, setup times, etc. that indicates potential duplicate optical fiber tests. Only if the testing condition score 844 satisfies that threshold (e.g., indicating a potential duplicate optical fiber test) will the similarity score 842 then be compared to a threshold similarity score. This may save computing resources (e.g., by avoiding unnecessary comparisons when duplicate optical fiber tests are not possible) and/or reduce false positives relative to alternative techniques. In some embodiments, rather than comparing both scores 842, 844 to respective thresholds, the scores 842, 844 may be combined (e.g., a weighted sum of the two scores 842, 844 may be calculated). This combination may be compared to a single threshold value to determine whether the first optical fiber test corresponding to the first fiber characterization data 802 and the second optical fiber test corresponding to the second fiber characterization data 804 are duplicate optical fiber tests.

Upon identifying that the first optical fiber test and the second optical fiber test represent duplicate optical fiber tests, the computing device may set a first flag (e.g., within the first associated metadata, within a memory of the computing device 810, and/or within a memory of the device 302) that indicates that results of the first optical fiber test are noncompliant and/or set a second flag (e.g., within the second associated metadata, within a memory of the computing device 810, and/or within a memory of the device 302) that indicates that results of the second optical fiber test are noncompliant. Additionally or alternatively, upon determining that the first optical fiber test and the second optical fiber test represent duplicate tests, the computing device 810 may output a prompt to a technician that requests that the first optical fiber test or the second optical fiber test be repeated (e.g., on the proper, non-duplicated optical fiber). In some embodiments, the technician may then perform a third optical fiber test. The third optical fiber test may be a repeat the first optical fiber test or the second optical fiber test, but on a different optical fiber (rather than the same optical fiber on which the first optical fiber test and the second optical fiber test were performed). A third fiber characterization data (e.g., and associated third associated metadata) may then be analyzed by the computing device 810 to ensure that the third optical fiber test is not a duplicate of the first optical fiber test or the second optical fiber test. Still further, if the results of the third optical fiber test indicate that the optical fiber under test in the third optical fiber test (e.g., as depicted in a third fiber characterization image, such as a fiber inspection image) is unsatisfactory, the optical fiber under test in the third optical fiber test may be repaired or replaced. For example, if an optical fiber test was purportedly conducted for the second optical fiber when, in fact, the optical fiber test was merely an inappropriate repeat of the first optical fiber test (e.g., to obfuscate a defective second optical fiber), a duplicate test may be identified. Then, upon detecting the duplicate optical fiber tests, a proper test of the second optical fiber may be initiated. If, upon initiating the proper test of the second optical fiber, it is determined that the second optical fiber is defective, the second optical fiber may then be repaired or replaced (e.g., by a technician).

Still further, the results of the analysis of the first fiber characterization data 802, the second fiber characterization data 804, the first associated metadata 832, and the second associated metadata 834 may be stored within a memory of the computing device 810 and/or within a memory of another computing device (e.g., a memory of the device 302). For example, the determined similarity score 842 and/or the determined testing condition score 844 may be stored for later retrieval and/or analysis.

As described herein (e.g., with reference to FIG. 8A), one or more machine-learned models may be used to generate embedding vectors based on fiber characterization data (e.g., OTDR traces, fiber inspection images, or OLTS data) related to optical fiber tests. These machine-learned model(s) may be trained using various techniques (e.g., similar to the technique shown and described with reference to FIG. 4A). FIG. 8B is a block diagram illustration of an example technique 890 for training a machine-learned model (e.g., the machine-learned model 820 shown and described with reference to FIG. 8A). The technique 890 of FIG. 8B may be performed by a computing device (e.g., the computing device 810 shown and described with reference to FIG. 8A or a different computing device). For example, in some embodiments, one computing device may train the machine-learned model 820 and then transfer the machine-learned model to another computing device (e.g., the computing device 810 shown and described with reference to FIG. 8A in order to perform the technique 800 illustrated in FIG. 8A). The technique 890 illustrated in FIG. 8B may be used to train the machine-learned model 820 (e.g., an ANN) using data triplets, for instance.

As illustrated in FIG. 8B, measured fiber characterization data 862 may be provided to a machine-learning training algorithm 860 (e.g., similar to the machine-learning training algorithm 460 shown and described with reference to FIG. 4A) and to a synthetic data generator 870. The measured fiber characterization data 862 may correspond to an OTDR trace, a fiber inspection image, or OLTS data captured by a device (e.g., the device 302 shown and described with reference to FIG. 3A) during an optical fiber test. For example, the synthetic data generator 870 may include one or more data manipulation steps (e.g., image processing steps) used to transform the measured fiber characterization data 862 into similar synthetic fiber characterization data 872 and one or more different data manipulation steps (e.g., different image processing steps) to transform the measured fiber characterization data 862 into disparate synthetic fiber characterization data 874. Upon receiving the measured fiber characterization data 862, the synthetic data generator 870 may generate two synthetic fiber characterization data. One of the synthetic fiber characterization data (e.g., the similar synthetic fiber characterization data 872) may be relatively similar to the measured fiber characterization data 862, while the other synthetic fiber characterization data (e.g., the disparate synthetic fiber characterization data 874) may be non-negligibly different from the measured fiber characterization data 862. For example, the similar synthetic fiber characterization data 872 may correspond to a slight shift, rotation, resizing, or change in focus relative to the measured fiber characterization data 862, whereas the disparate synthetic fiber characterization data 874 may be completely different data from the measured fiber characterization data 862 (e.g., the disparate synthetic fiber characterization data 874 may be a fiber inspection image containing different artifacts or optical fiber imperfections). While FIG. 8B illustrates the synthetic data generator 870 generating similar synthetic fiber characterization data and disparate synthetic fiber characterization data, it is understood that other sources of fiber characterization data are also possible (e.g., rather than being synthetically generated). For example, one or both of the similar synthetic fiber characterization data and the disparate synthetic fiber characterization data could be replaced by additionally measured fiber characterization data (e.g., that is similar to or disparate from the underlying measured fiber characterization data). In some embodiments, the synthetic data generator 870 may, itself, be a machine-learned model used to perform data manipulation.

The machine-learning training algorithm 860 may then use the measured fiber characterization data 862, the similar synthetic fiber characterization data 872, and the disparate synthetic fiber characterization data 874 to train the machine-learned model 820. The training process employed by the machine-learning training algorithm 860 may include generating embedding vectors for each of the measured fiber characterization data 862, the similar synthetic fiber characterization data 872, and the disparate synthetic fiber characterization data 874; minimizing the Euclidean distance between the embedding vectors of the measured fiber characterization data 862 and the similar synthetic fiber characterization data 872; and maximizing the Euclidean distance between the embedding vectors of the measured fiber characterization data 862 and the disparate synthetic fiber characterization data 874 (e.g., effectively training the machine-learned model 820 to recognize and encode invariant features). Once trained, the machine-learned model 820 may be configured to produce embedding vectors that capture characteristics of the fiber characterization data that indicate similarity. Further, Euclidean distances between embedding vectors produced using the machine-learned model 820 may provide measures of similarity between fiber characterization data pairs. While FIG. 8B only shows the use of a single set of measured fiber characterization data 862, a single set of generated similar synthetic fiber characterization data 872, and a single set of disparate synthetic fiber characterization data 874 to train the machine-learned model 820 using the machine-learning training algorithm 860, it is understood that this is shown merely as an example. In some embodiments, many triplet sets of measured fiber characterization data, similar synthetic fiber characterization data, and disparate synthetic fiber characterization data may be used to train the machine-learned model 860.

### III. Example Processes

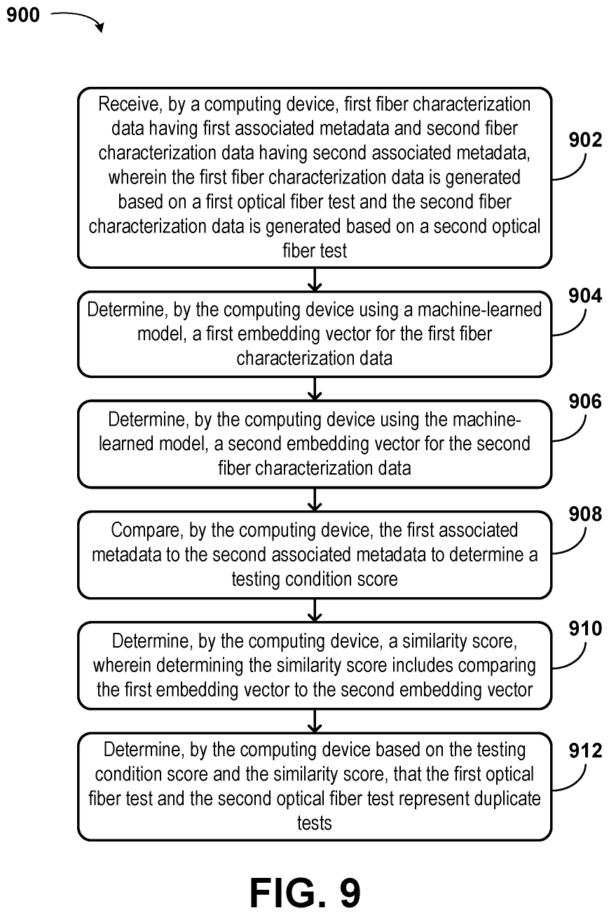

FIG. 9 is a flowchart diagram illustrating a method 900, according to example embodiments. In some embodiments, the method 900 may be performed by a system (e.g., the system 300 shown and described with reference to FIG. 3A or a combination of the device 302 and the computing device 810 shown and described with reference to FIG. 8A).

At block 902, the method 900 may include receiving, by a computing device, first fiber characterization data having first associated metadata and second fiber characterization data having second associated metadata, wherein the first fiber characterization data is generated based on a first optical fiber test and the second fiber characterization data is generated based on a second optical fiber test.

At block 904, the method 900 may include determining, by the computing device using a machine-learned model, a first embedding vector for the first fiber characterization data.

At block 906, the method 900 may include determining, by the computing device using the machine-learned model, a second embedding vector for the second fiber characterization data.

At block 908, the method 900 may include comparing, by the computing device, the first associated metadata to the second associated metadata to determine a testing condition score.

At block 910, the method 900 may include determining, by the computing device, a similarity score, wherein determining the similarity score includes comparing the first embedding vector to the second embedding vector.

At block 912, the method 900 may include determining, by the computing device based on the testing condition score and the similarity score, that the first optical fiber test and the second optical fiber test represent duplicate tests.

In some embodiments of the method 900, the first fiber characterization data may include a first OTDR trace. The second fiber characterization data may include a second OTDR trace.

In some embodiments of the method 900, the first fiber characterization data may include a first fiber inspection image. The second fiber characterization image may include a second fiber inspection image.

In some embodiments of the method 900, the first fiber characterization data may include a first set of OLTS data (e.g., measured from multiple fibers using a MPO connector). The second fiber characterization image may include a second set of OLTS data (e.g., measured from multiple fibers using a MPO connector).

Additionally, in some embodiments of the method 900, the first fiber inspection image may include an image of a defect of an optical fiber under test during the first optical fiber test or the second fiber inspection image may include an image of a defect of an optical fiber under test during the second optical fiber test.

Further, in some embodiments of the method 900, the first fiber inspection image may include an image of a cladding region of an optical fiber under test during the first optical fiber test or the second fiber inspection image may include an image of a cladding region of an optical fiber under test during the second optical fiber test.

In addition, in some embodiments, the method 900 may include identifying, by the computing device, a plurality of first regions of interest within the first fiber inspection image. The method 900 may also include identifying, by the computing device, a plurality of second regions of interest within the second fiber inspection image, wherein the first embedding vector for the first fiber characterization data may include an embedding vector for a primary region of interest within the plurality of first regions of interest, and wherein the second embedding vector for the second fiber characterization data may include an embedding vector for a primary region of interest within the plurality of second regions of interest. Additionally, the method 900 may include determining, by the computing device using the machine-learned model, a third embedding vector for the first fiber characterization data, wherein the third embedding vector for the first fiber characterization data may include an embedding vector for a secondary region of interest within the plurality of first regions of interest. Further, the method 900 may include determining, by the computing device using the machine-learned model, a fourth embedding vector for the second fiber characterization data, wherein the fourth embedding vector for the second fiber characterization data may include an embedding vector for a secondary region of interest within the plurality of second regions of interest, and wherein block 910 may further include comparing the third embedding vector to the fourth embedding vector.

In some embodiments of the method 900, block 910 may include determining a Euclidean distance between the first embedding vector and the second embedding vector.

In some embodiments of the method 900, block 910 may include determining, based on a clustering technique, that the first embedding vector and the second embedding vector are members of a common cluster.

Additionally, in some embodiments of the method 900, the clustering technique may include a graph clustering technique or a k-means clustering technique.

Further, in some embodiments of the method 900, determining that the first embedding vector and the second embedding vector are members of the common cluster may include determining a Euclidean distance between the first embedding vector and the second embedding vector. Determining that the first embedding vector and the second embedding vectors are members of the common cluster may also include comparing the Euclidean distance to a threshold distance. The threshold distance may be determined based on Euclidean distances between sample embedding vectors determined using the machine-learned model. The sample embedding vectors may correspond to labelled embedding vectors that represent duplicate optical fiber tests and labelled embedding vectors that represent non-duplicated optical fiber tests.

In some embodiments of the method 900, block 908 may include determining a time between tests or a testing rate based on a difference between a first testing time contained within the first associated metadata and a second testing time contained within the second associated metadata.

In some embodiments of the method 900, block 908 may include determining a distance between tests based on a difference between a first testing location contained within the first associated metadata and a second testing location contained within the second associated metadata.

In some embodiments of the method 900, the machine-learned model may include an artificial neural network. The artificial neural network may have been trained using data triplets.

In some embodiments of the method 900, block 908 may include determining whether a first test type associated with the first optical fiber test and a second test type associated with the second optical fiber test are the same. For example, if the first test type and the second test type are the same (e.g., if both tests are OTDR measurements or both tests generate OLTS data), the testing condition score may be increased (e.g., indicating a higher likelihood of duplicated tests).

In some embodiments, the method 900 may also include, upon determining that the first optical fiber test and the second optical fiber test represent duplicate tests, setting a first flag within the first associated metadata indicating that results of the first optical fiber test are noncompliant or setting a second flag within the second associated metadata indicating that results of the second optical fiber test are noncompliant.

In some embodiments, the method 900 may also include determining, by the computing device, that the testing condition score exceeds a threshold used to identify a potential duplicate test. Further, block 910 may be performed upon determining that the testing condition score exceeds the threshold used to identify the potential duplicate test.

Additionally, in some embodiments of the method 900, the threshold used to identify the potential duplicate test may correspond to a testing rate that exceeds 90%, 95%, 99%, or 99.9% of testing rates across optical fiber tests within a testing dataset or a test setup time that is less than 90%, 95%, 99%, or 99.9% of test setup times across the optical fiber tests within the testing dataset.

In some embodiments, the method 900 may also include receiving, by the computing device, a user selection of a value for the threshold used to identify the potential duplicate test.

In some embodiments, the method 900 may also include, upon completing block 912, outputting a prompt to a technician. The prompt may request that the first optical fiber test or the second optical fiber test be repeated on an indicated optical fiber. In some embodiments, for example, the indicated optical fiber may correspond to an optical fiber that was improperly untested as a result of the duplicated optical fiber tests (the first optical fiber test and the second optical fiber test).

Additionally, in some embodiments, the method 900 may include performing a third optical fiber test that represents a repeat of the first optical fiber test or the second optical fiber test on the indicated optical fiber. Performing the third optical fiber test may include generating third fiber characterization data. The method 900 may also include identifying, based on the third fiber characterization data, a defect in the indicated optical fiber. Further, the method 900 may include repairing or replacing the indicated optical fiber based on the identified defect.

### IV. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

The computer-readable medium can also include non-transitory computer-readable media such as computer-readable media that store data for short periods of time like register memory and processor cache. The computer-readable media can further include non-transitory computer-readable media that store program code and/or data for longer periods of time. Thus, the computer-readable media may include secondary or persistent long term storage, like ROM, optical or magnetic disks, solid state drives, compact-disc read only memory (CD-ROM), for example. The computer-readable media can also be any other volatile or non-volatile storage systems. A computer-readable medium can be considered a computer-readable storage medium, for example, or a tangible storage device.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed:

1. A method comprising:
receiving, by a computing device, first fiber characterization data having first associated metadata and second fiber characterization data having second associated metadata, wherein the first fiber characterization data is generated based on a first optical fiber test and the second fiber characterization data is generated based on a second optical fiber test;
determining, by the computing device using a machine-learned model, a first embedding vector for the first fiber characterization data;
determining, by the computing device using the machine-learned model, a second embedding vector for the second fiber characterization data;
comparing, by the computing device, the first associated metadata to the second associated metadata to determine a testing condition score;
determining, by the computing device, a similarity score, wherein determining the similarity score comprises comparing the first embedding vector to the second embedding vector; and
determining, by the computing device based on the testing condition score and the similarity score, that the first optical fiber test and the second optical fiber test represent duplicate tests.

2. The method of claim 1, wherein the first fiber characterization data comprises a first optical time-domain reflectometry (OTDR) trace and the second fiber characterization data comprises a second OTDR trace, or wherein the first fiber characterization data comprises a first set of OLTS data and the second fiber characterization data comprises a second set of OLTS data.

3. The method of claim 1, wherein the first fiber characterization data comprises a first fiber inspection image, and wherein the second fiber characterization data comprises a second fiber inspection image.

4. The method of claim 3, wherein the first fiber inspection image comprises an image of a defect of an optical fiber under test during the first optical fiber test or the second fiber inspection image comprises an image of a defect of an optical fiber under test during the second optical fiber test.

5. The method of claim 3, wherein the first fiber inspection image comprises an image of a cladding region of an optical fiber under test during the first optical fiber test or the second fiber inspection image comprises an image of a cladding region of an optical fiber under test during the second optical fiber test.

6. The method of claim 3, further comprising:
identifying, by the computing device, a plurality of first regions of interest within the first fiber inspection image;
identifying, by the computing device, a plurality of second regions of interest within the second fiber inspection image, wherein the first embedding vector for the first fiber characterization data comprises an embedding vector for a primary region of interest within the plurality of first regions of interest, and wherein the second embedding vector for the second fiber characterization data comprises an embedding vector for a primary region of interest within the plurality of second regions of interest;
determining, by the computing device using the machine-learned model, a third embedding vector for the first fiber characterization data, wherein the third embedding vector for the first fiber characterization data comprises an embedding vector for a secondary region of interest within the plurality of first regions of interest; and
determining, by the computing device using the machine-learned model, a fourth embedding vector for the second fiber characterization data, wherein the fourth embedding vector for the second fiber characterization data comprises an embedding vector for a secondary region of interest within the plurality of second regions of interest, and wherein determining the similarity score further comprises comparing the third embedding vector to the fourth embedding vector.

7. The method of claim 1, wherein comparing the first embedding vector to the second embedding vector comprises determining a Euclidean distance between the first embedding vector and the second embedding vector.

8. The method of claim 1, wherein comparing the first embedding vector to the second embedding vector comprises determining, based on a clustering technique, that the first embedding vector and the second embedding vector are members of a common cluster.

9. The method of claim 8, wherein the clustering technique comprises a graph clustering technique or a k-means clustering technique, or wherein the machine-learned model comprises an artificial neural network that was trained using data triplets.

10. The method of claim 8, wherein determining that the first embedding vector and the second embedding vector are members of the common cluster comprises:
determining a Euclidean distance between the first embedding vector and the second embedding vector; and
comparing the Euclidean distance to a threshold distance, wherein the threshold distance is determined based on Euclidean distances between sample embedding vectors determined using the machine-learned model, and wherein the sample embedding vectors correspond to labelled embedding vectors that represent duplicate optical fiber tests and labelled embedding vectors that represent non-duplicated optical fiber tests.

11. The method of claim 1, wherein comparing the first associated metadata to the second associated metadata to determine the testing condition score comprises determining a time between tests or a testing rate based on a difference between a first testing time contained within the first associated metadata and a second testing time contained within the second associated metadata.

12. The method of claim 1, wherein comparing the first associated metadata to the second associated metadata to determine a testing condition score comprises determining a distance between tests based on a difference between a first testing location contained within the first associated metadata and a second testing location contained within the second associated metadata.

13. The method of claim 1, wherein comparing the first associated metadata to the second associated metadata to determine the testing condition score comprises determining whether a first test type associated with the first optical fiber test and a second test type associated with the second optical fiber test are the same.

14. The method of claim 1, further comprising, upon determining that the first optical fiber test and the second optical fiber test represent duplicate tests:
setting a first flag within the first associated metadata indicating that results of the first optical fiber test are noncompliant; or
setting a second flag within the second associated metadata indicating that results of the second optical fiber test are noncompliant.

15. The method of claim 1, further comprising determining, by the computing device, that the testing condition score exceeds a threshold used to identify a potential duplicate test, wherein the first embedding vector is compared to the second embedding vector to determine the similarity score upon determining that the testing condition score exceeds the threshold used to identify the potential duplicate test.

16. The method of claim 15, wherein:
the threshold used to identify the potential duplicate test corresponds to a testing rate that exceeds 90%, 95%, 99%, or 99.9% of testing rates across optical fiber tests within a testing dataset or a test setup time that is less than 90%, 95%, 99%, or 99.9% of test setup times across the optical fiber tests within the testing dataset; or
the method further comprises receiving, by the computing device, a user selection of a value for the threshold used to identify the potential duplicate test.

17. The method of claim 1, further comprising, upon determining that the first optical fiber test and the second optical fiber test represent duplicate tests, outputting a prompt to a technician, wherein the prompt requests that the first optical fiber test or the second optical fiber test be repeated on an indicated optical fiber.

18. The method of claim 17, further comprising:
performing a third optical fiber test that represents a repeat of the first optical fiber test or the second optical fiber test on the indicated optical fiber, wherein performing the third optical fiber test comprises generating third fiber characterization data;
identifying, based on the third fiber characterization data, a defect in the indicated optical fiber; and
repairing or replacing the indicated optical fiber based on the identified defect.

19. A non-transitory, computer-readable medium having instructions stored therein, wherein the instructions, when executed by a processor, perform a method comprising:
receiving first fiber characterization data having first associated metadata and second fiber characterization data having second associated metadata, wherein the first fiber characterization data is generated based on a first optical fiber test and the second fiber characterization data is generated based on a second optical fiber test;
determining, using a machine-learned model, a first embedding vector for the first fiber characterization data;
determining, using the machine-learned model, a second embedding vector for the second fiber characterization data;
comparing the first associated metadata to the second associated metadata to determine a testing condition score;
determining a similarity score, wherein determining the similarity score comprises comparing the first embedding vector to the second embedding vector; and
determining, based on the testing condition score and the similarity score, that the first optical fiber test and the second optical fiber test represent duplicate tests.

20. A system comprising:
a fiber characterization device comprising:
an optical time-domain reflectometry (OTDR) device comprising:
a laser configured to emit a series of light pulses into an optical fiber; and
a light detector configured to acquire a plurality of OTDR traces, wherein the OTDR traces represent backscatter from respective light pulses of the series of emitted light pulses propagated through the optical fiber; or
a fiber inspection probe configured to acquire a plurality of fiber inspection images; and
a computing device communicatively coupled with the fiber characterization device, wherein the computing device is configured to:
receive, from the fiber characterization device, first fiber characterization data having first associated metadata and second fiber characterization data having second associated metadata, wherein the first fiber characterization data is generated based on a first optical fiber test and the second fiber characterization data is generated based on a second optical fiber test;
determine, using a machine-learned model, a first embedding vector for the first fiber characterization data;
determine, using the machine-learned model, a second embedding vector for the second fiber characterization data;
compare the first associated metadata to the second associated metadata to determine a testing condition score;
determine a similarity score, wherein determining the similarity score comprises comparing the first embedding vector to the second embedding vector; and
determine, based on the testing condition score and the similarity score, that the first optical fiber test and the second optical fiber test represent duplicate tests.
